(19) United States
(12) Patent Application Publication
(10) Pub. No.: US 2022/0093088 A1
(43) Pub. Date: Mar. 24, 2022

(54) CONTEXTUAL SENTENCE EMBEDDINGS FOR NATURAL LANGUAGE PROCESSING APPLICATIONS

(71) Applicant: Apple Inc., Cupertino, CA (US)

(72) Inventors: Vivek Kumar RANGARAJAN SRIDHAR, Los Altos, CA (US); Barada Prasanna Acharya, Sunnyvale, CA (US); Douglas Ross Davidson, Palo Alto, CA (US); Xingwen XU, Milpitas, CA (US)

(21) Appl. No.: 17/031,798

(22) Filed: Sep. 24, 2020

(51) Int. Cl. G10L 15/197; G10L 15/18

(52) U.S. Cl. CPC G10L 15/197; G10L 15/1815

(57) ABSTRACT

Methods and systems for embedding natural language sentences within a highly-dimensional vector space are provided. Additionally, various applications relating to natural language processing, are provided. Such applications include digital assistants and search engines, as well as systems for classifying, sorting, organizing, and/or pairing content that are associated with natural language objects. The sentence vector embeddings encode various semantic features of the sentence. Two separate language models, arranged in a serial architecture are employed to generate a sentence vector. The first language model generates token vectors for each of the tokens included in the sentence. The token vectors are employed as inputs to the second language model. The second language model generates the sentence vector for the sentence. A sentence vector embeds the semantic context of the corresponding natural language object within the vector space. The second language model may be trained via supervised learning on multiple semantic-related tasks.

### FIELD

This relates generally to intelligent automated assistants and, more specifically, to operating a digital assistant to generate and provide reports targeted to a user.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

### SUMMARY

Systems, methods, and electronic devices for operating an electronic device and generating sentence embeddings are provided.

Example methods are disclosed herein. An example method for operating an electronic device includes: in accordance with receiving a first n-gram at the electronic device, employing one or more processors and a memory of the electronic device to perform operations. The first n-gram may include a first set tokens. The first n-gram may represent a first semantic context within a first natural language. The first n-gram may be associated with a first natural language. The first set of tokens may be an ordered set of tokens of the first natural language. The operations may comprise employing a first language model to generate a token vector for each token in the first set of tokens. A second language model and the token vector of each token in the first set of tokens may be employed to generate a first sentence vector. The first sentence vector may be a sentence embedding for the first n-gram. The first sentence vector may embed the first semantic context within a vector space of the second language model. A second n-gram may be selected from a plurality of other n-grams. The selection of the second n-gram may be based on a semantic relationship between the first semantic context and a second semantic context. The second semantic context may be represented by the second n-gram. The semantic relationship may be based on the first sentence vector. The second n-gram may be associated with a second natural language.

Example non-transitory computer-readable storage mediums are disclosed herein. An example non-transitory computer-readable storage medium stores one or more programs. The one or more programs comprise instructions, which when executed by one or more processors of an electronic device, operate an electronic device, by performing actions. The actions may include receiving a first n-gram. The first n-gram may include a first set tokens. The first n-gram may represent a first semantic context within a first natural language. The first n-gram may be associated with a first natural language. The first set of tokens may be an ordered set of tokens of the first natural language. The operations may comprise employing a first language model to generate a token vector for each token in the first set of tokens. A second language model and the token vector of each token in the first set of tokens may be employed to generate a first sentence vector. The first sentence vector may be a sentence embedding for the first n-gram. The first sentence vector may embed the first semantic context within a vector space of the second language model. A second n-gram may be selected from a plurality of other n-grams. The selection of the second n-gram may be based on a semantic relationship between the first semantic context and a second semantic context. The second semantic context may be represented by the second n-gram. The semantic relationship may be based on the first sentence vector. The second n-gram may be associated with a second natural language.

Example electronic devices are disclosed herein. An example electronic device comprises one or more processors; a memory; and one or more programs, where the one or more programs are stored in the memory and configured to be executed by the one or more processors, the one or more programs including instructions for actions. The actions may include receiving a first n-gram. The first n-gram may include a first set tokens. The first n-gram may represent a first semantic context within a first natural language. The first n-gram may be associated with a first natural language. The first set of tokens may be an ordered set of tokens of the first natural language. The operations may comprise employing a first language model to generate a token vector for each token in the first set of tokens. A second language model and the token vector of each token in the first set of tokens may be employed to generate a first sentence vector. The first sentence vector may be a sentence embedding for the first n-gram. The first sentence vector may embed the first semantic context within a vector space of the second language model. A second n-gram may be selected from a plurality of other n-grams. The selection of the second n-gram may be based on a semantic relationship between the first semantic context and a second semantic context. The second semantic context may be represented by the second n-gram. The semantic relationship may be based on the first sentence vector. The second n-gram may be associated with a second natural language.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4 is a block diagram of an exemplary multifunction device with a display and a touch-sensitive surface, according to various examples.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates an environment for generating a sentence embedding for an inputted sentence, according to various embodiments.

FIG. 9 illustrates an example of multitask training for a sentence embedding language model, according to various embodiments.

FIG. 10A illustrates a process for generating and employing a semantic sentence embedding, according to various embodiments.

FIG. 10B illustrates a process for generating a database of reference sentence embeddings, consistent with various embodiments.

FIG. 11 illustrates a non-limiting example of employing a clustering method to generate a plurality of sentence clusters from a corpus of sentences.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

Various embodiments are directed towards embedding a natural language sentence within a vector space of a language model. The sentence embeddings may be used in various natural language processing (NLP) applications. As articulated below, the term “sentence” is not intended to be limited, and as used throughout, the term “sentence” may refer to any natural language object of arbitrary length. For instance, the term “sentence” may refer to a grammatically correct (or incorrect) complete (or incomplete) sentence, a sentence fragment, a phrase, multiple sentences, a clause, a stanza, musical lyrics, one or more words, or any other collections of tokens (e.g., words, punctuation, and the like) that represent a semantic context (e.g., meaning, concept idea, theme, and the like) within one or more natural languages (e.g., English, Spanish, French, and the like). Therefore, a sentence may refer to any natural language content that may be encoded as an n-gram data structure of arbitrary length, e.g., a set of ordered natural language tokens.

More specifically, the embodiments may employ two separate language models, arranged in a serial architecture to generate a vector (e.g., a sentence vector) for a received sentence. The first language model receives an n-gram data structure (e.g., encoding the received sentence) and generates token vectors for each of the tokens of the received sentence. The token vectors embed each of the tokens in a vector space of the first language model. The token vectors and/or the received sentence are employed as inputs to the second language model. The second language model generates a sentence vector for the sentence. The sentence vector is embedded in a vector space of the second language model, which may be separate than the vector space of the first model. Thus, a sentence vector (generated from an input sentence) may be said to embed the sentence in the vector space of the language model. The sentence vector may also be said to embed the semantic context of the corresponding natural language sentence within the vector space. Accordingly, the first language model may be referred to as a token (or word) embedding model, while the second language model may be referred to as a sentence embedding model.

Due to at least multitask training of the second language model, the semantic context of a sentence may be determined from its vector embedding. Furthermore, semantic relationships between sentences may be determined from spatial relationships between their corresponding vector embeddings. Thus, the sentence embeddings of the various embodiments may be referred to as sentence semantic embeddings. The sentence embeddings of the embodiments may be employed in various NLP applications. The sentence embeddings may be utilized in any NLP application that processes natural language input. Such NLP applications include, but are not otherwise limited to, applications that may benefit from determining a semantic context of an input sentence and/or determining a semantic relationship between two or more sentences.

In non-limiting embodiments discussed herein, sentence embeddings may be employed to enhance the user experience when interacting with various systems (e.g., providing unrecognized paraphrasings of recognized commands to a digital assistant), as well as to enhance the performance of search engines (e.g., both text searches and image searches). Still other embodiments may be employed to sort content (e.g., recommending appropriate folders for electronic messages, files, and internet bookmarks), provide language translation services, find content within a search space that has a similar theme as an input sentence, pair semantically similar content to generate multimedia presentations, text search engines, image search engines, and the like.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

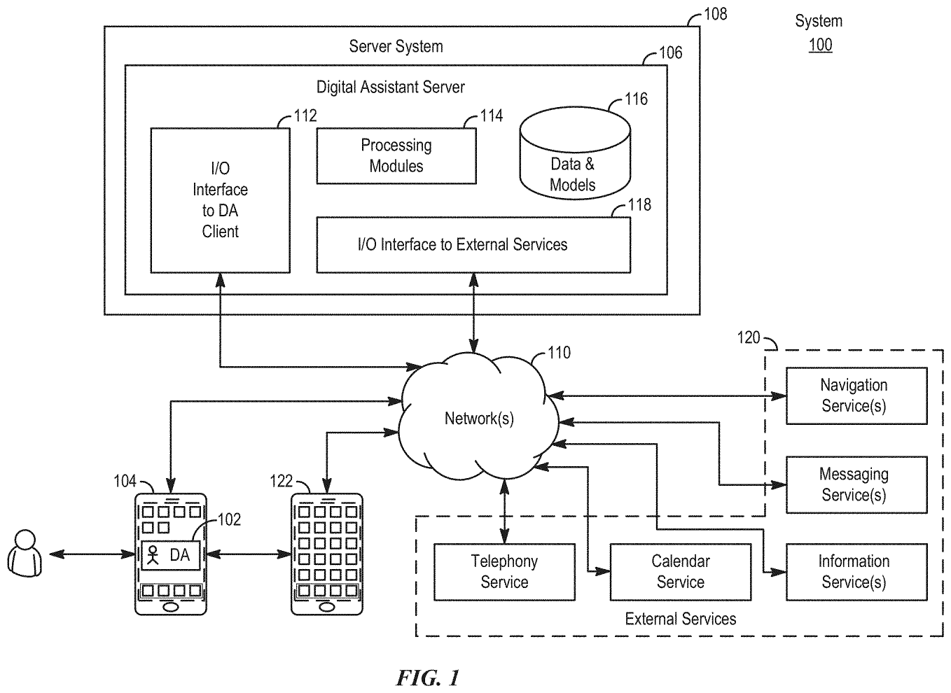

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

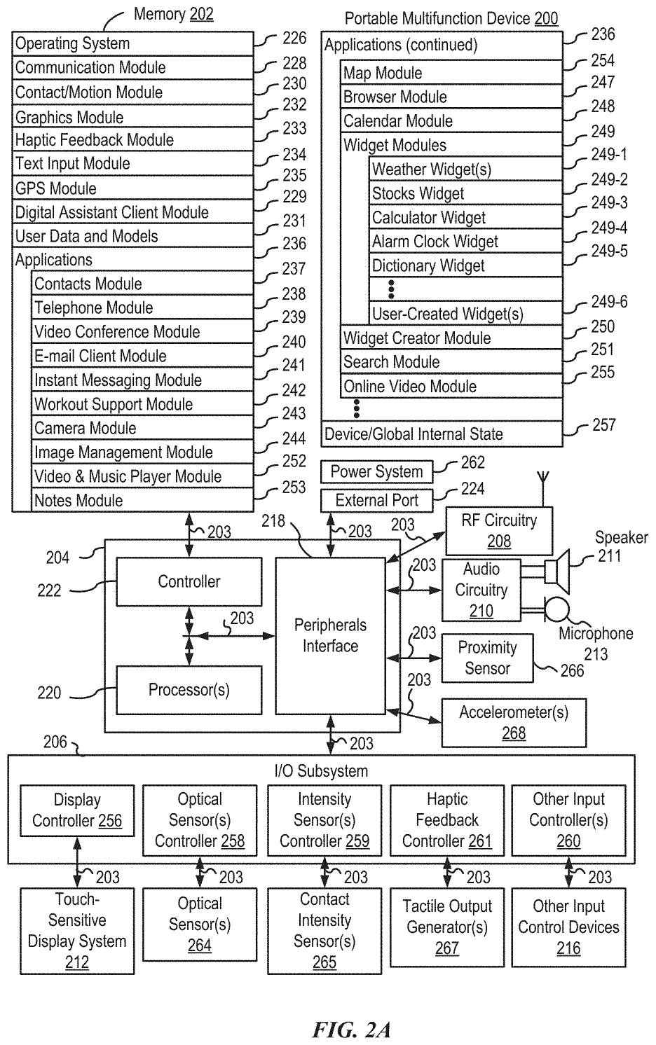

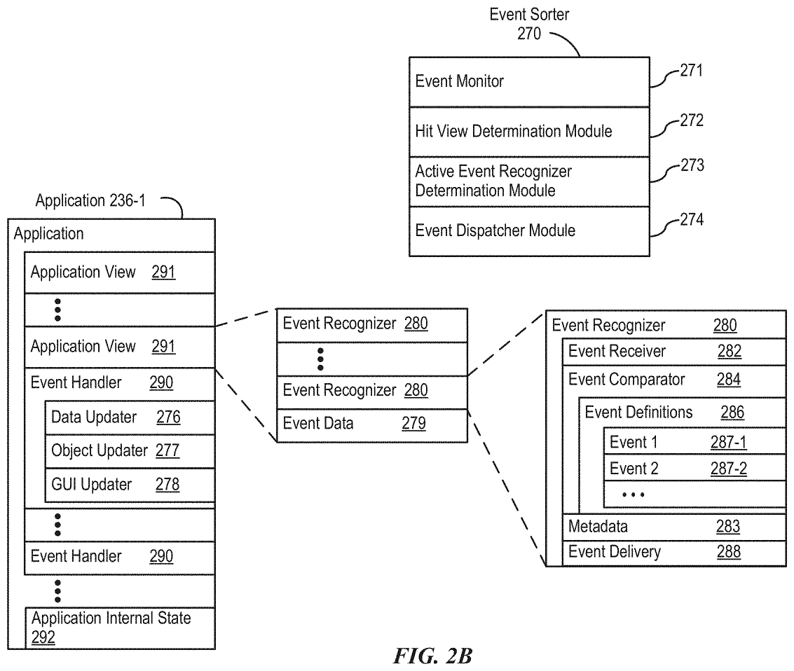

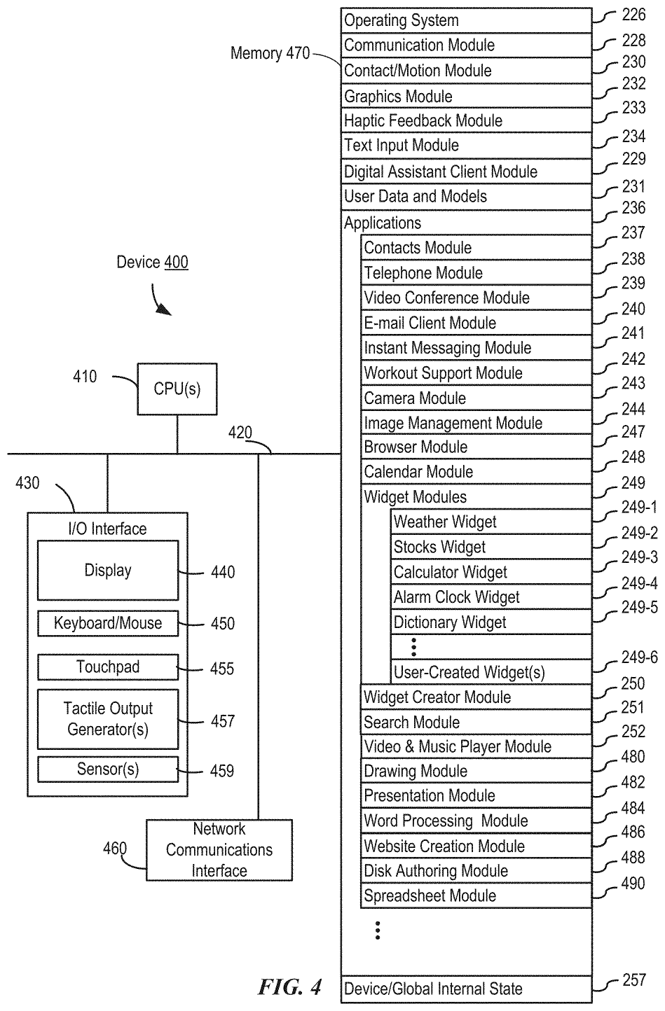

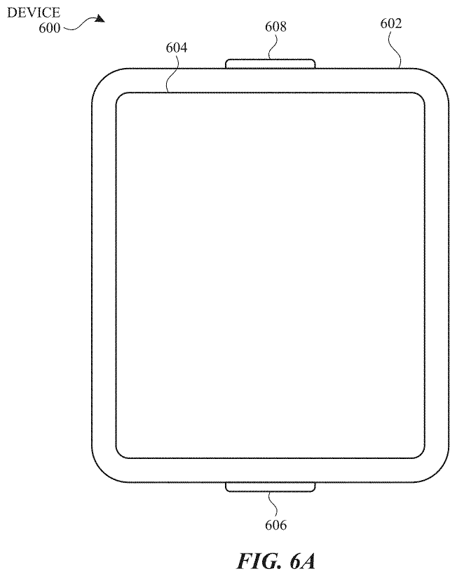

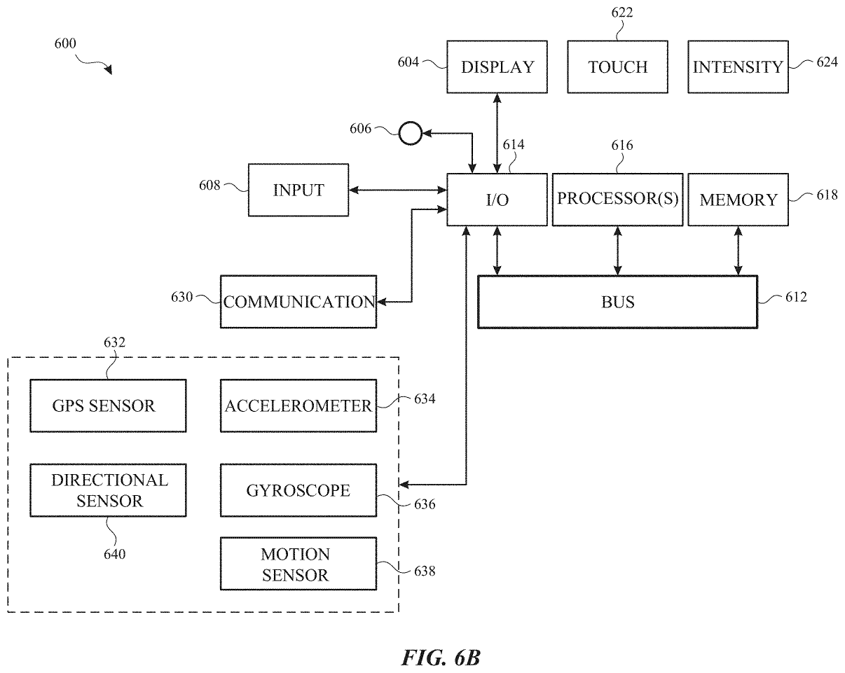

User device 104 can be any suitable electronic device. In some examples, user device 104 is a portable multifunctional device (e.g., device 200, described below with reference to FIG. 2A), a multifunctional device (e.g., device 400, described below with reference to FIG. 4), or a personal electronic device (e.g., device 600, described below with reference to FIGS. 6A-B.) A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, Calif. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4, and 6A-B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

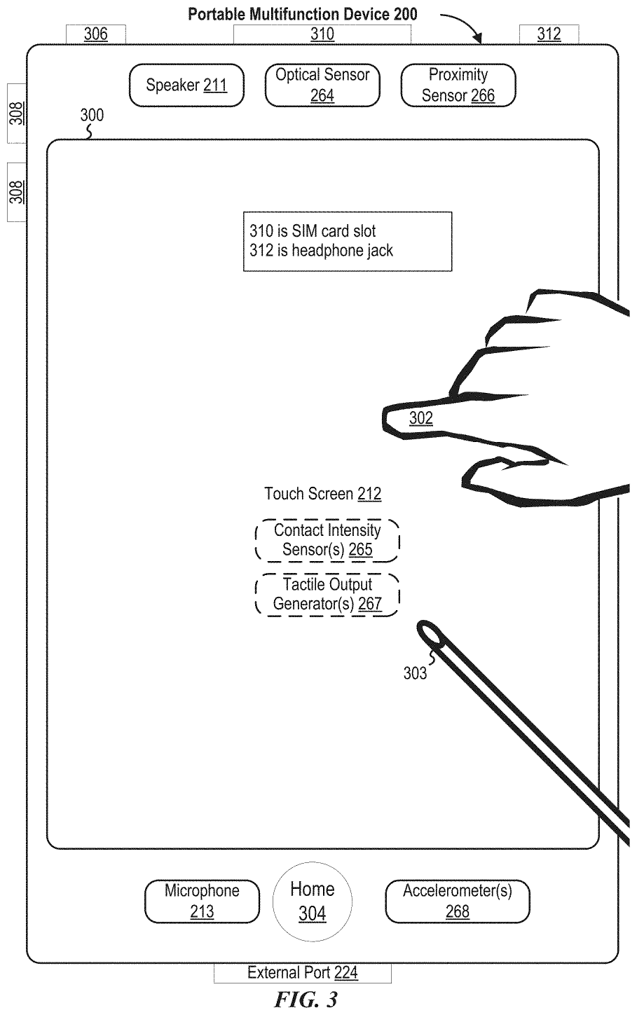

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, Calif.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts 237, email 240, IM 241, browser 247, and any other application that needs text input).

GPS module 235 determines the location of the device and provides this information for use in various applications (e.g., to telephone 238 for use in location-based dialing; to camera 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

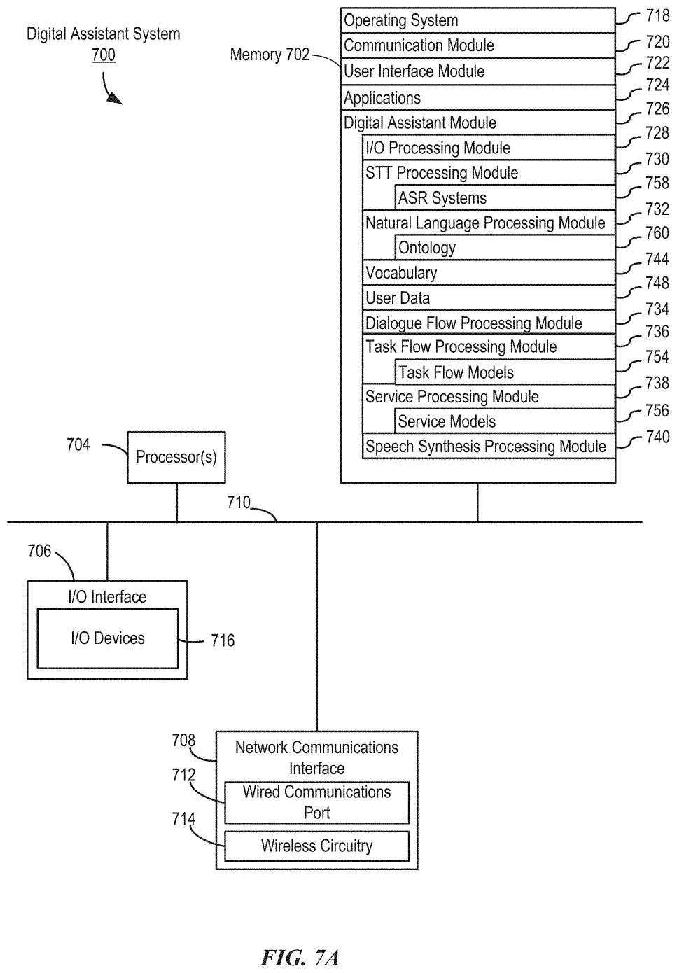

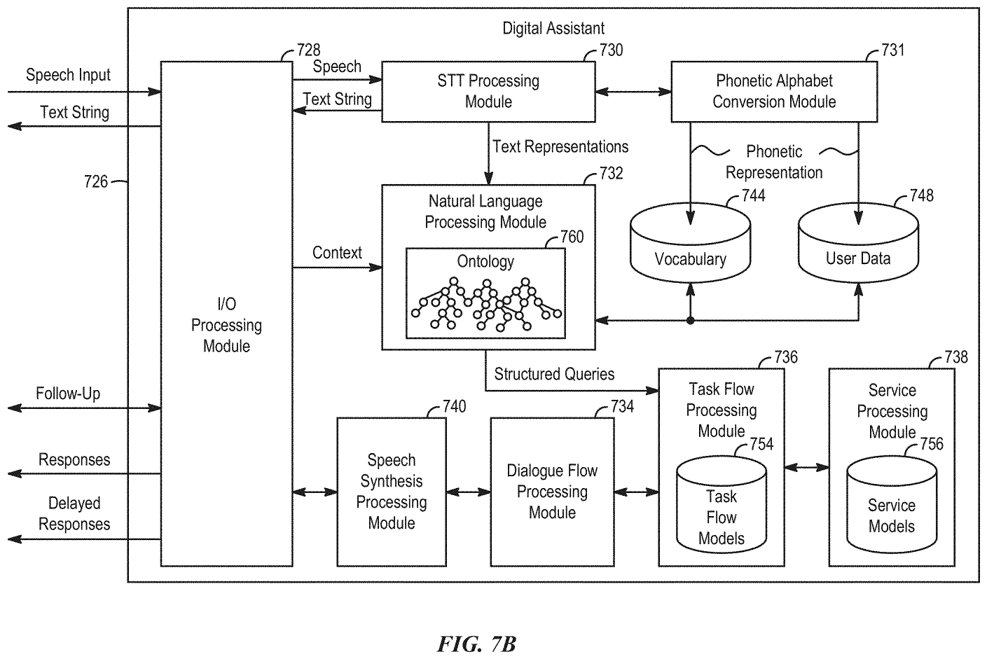

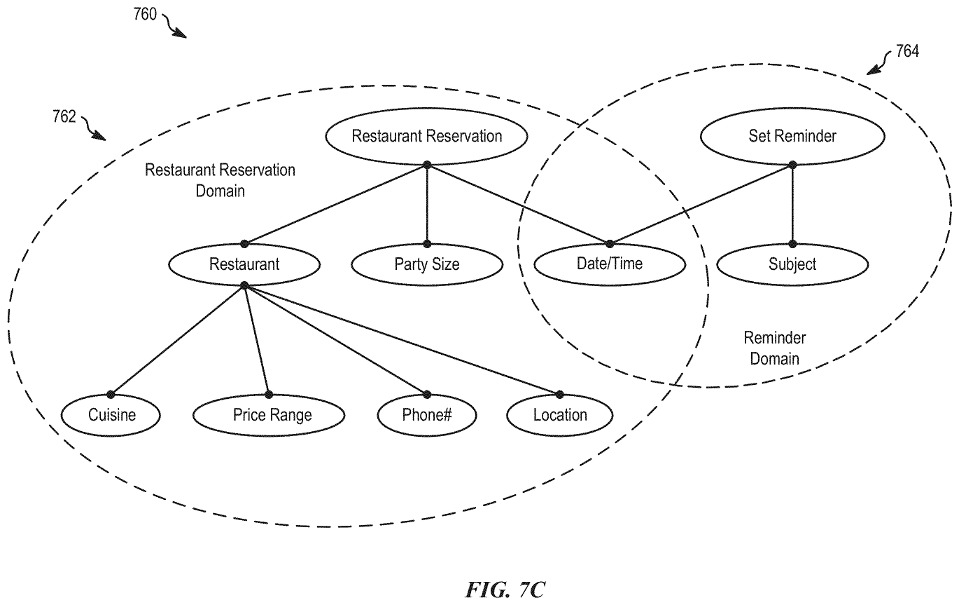

A more detailed description of a digital assistant is described below with reference to FIGS. 7A-C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference module 239, e-mail 240, or IM 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4 is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4 is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Attention is now directed towards embodiments of user interfaces that can be implemented on, for example, portable multifunction device 200.

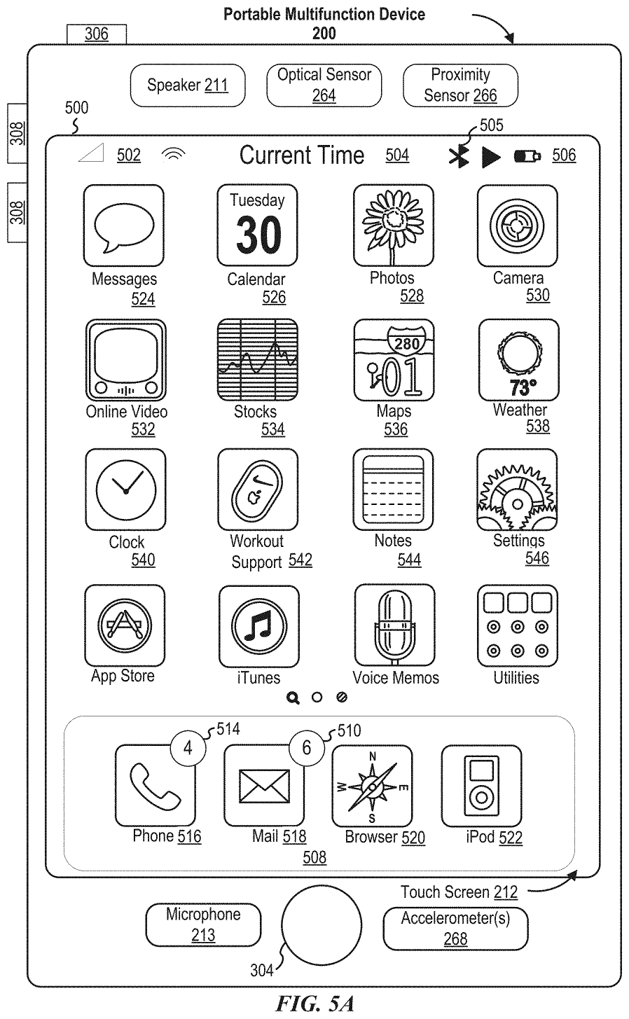

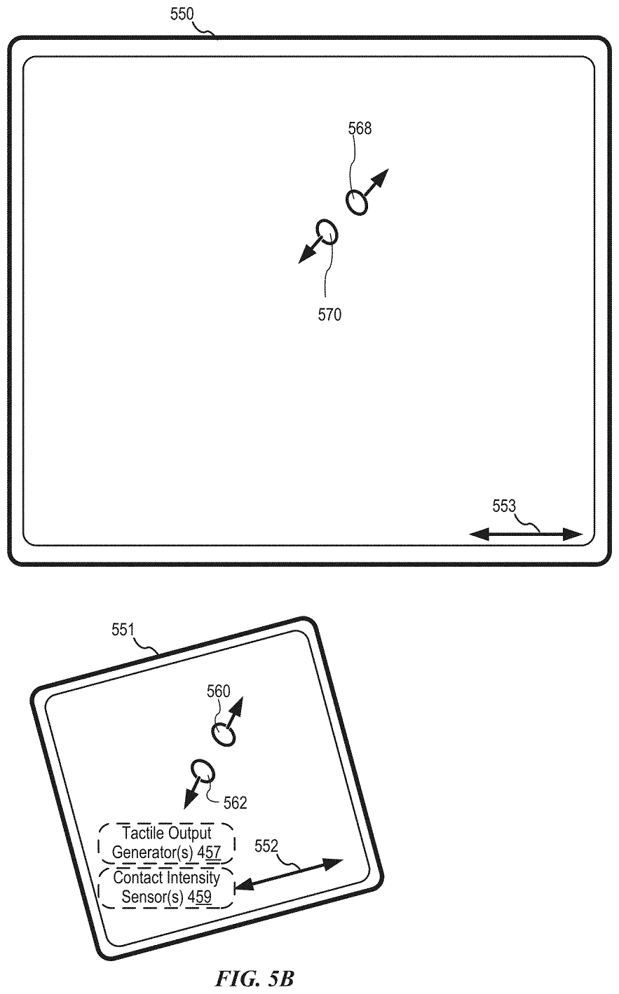

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4) with a touch-sensitive surface 551 (e.g., a tablet or touchpad 455, FIG. 4) that is separate from the display 550 (e.g., touch screen display 212). Device 400 also, optionally, includes one or more contact intensity sensors (e.g., one or more of sensors 457) for detecting intensity of contacts on touch-sensitive surface 551 and/or one or more tactile output generators 459 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, and/or 600 (FIGS. 2A, 4, and 6A-B). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4 or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, or 600) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, or 600 in FIGS. 2A, 4, 6A-B, respectively. In some examples, digital assistant system 700 represents the server portion of a digital assistant implementation, and can interact with the user through a client-side portion residing on a user device (e.g., devices 104, 200, 400, or 600).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4, 6A-B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of [symbol] and [symbol] . Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation [symbol] is ranked higher than [symbol] , because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation [symbol] is associated with the United States, whereas the candidate pronunciation [symbol] is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation [symbol] (associated with the United States) is ranked higher than the candidate pronunciation [symbol] (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes [symbol] corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes [symbol] corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

### 4. Sentence Embeddings

As used throughout, the term “natural language object” (or simply an object) may refer to a complete sentence (as normally understood in the grammar of a natural language), sentence fragment, question, answer, statement, phrase, clause, stanza, lyric, title of an artistic work, caption for an image, figure, or table, one or more words, or any other such object associated with a natural language. In various embodiments, a natural language object may be encoded as an n-gram data structure that includes an ordered set of natural language tokens (e.g., words, punctuation, alphanumeric characters, and the like). The natural language object may include an arbitrary number of words, punctuation, or other tokens of the natural language. Thus the value of n for an n-gram may be any unbounded positive integer. A natural language object may have an inherent semantic context (e.g., a meaning, idea, concept, statement, theme, or the like) that is inferable from a parsing of the ordered set of tokens and an understanding of the associated natural language and its associated grammar.

The term “sentence” is used throughout to refer to virtually any natural language object (as understood above), such as but not limited to a complete sentence, sentence fragment, question, answer, statement, phrase, clause, stanza, lyric, title of an artistic work, or any other such object. Thus, it is understood that the terms “natural language object” and “sentence” may be used interchangeably throughout. Thus, a sentence may be encoded as an n-gram, where the number of tokens (i.e., n) is arbitrary. Furthermore, a sentence may have an inherent semantic context (e.g., a meaning, idea, concept, statement, theme, or the like) that is inferable from a parsing of the ordered set of tokens and an understanding of the associated natural language and its associated grammar. In one non-limiting example, the sentence (or natural language object): “How to bake a cake without eggs” may be encoded in the following n-gram: (“How”, “to”, “bake”, “a”, “cake”, “without”, “eggs”), where n=7. Note that the encoding n-gram is an ordered set of seven tokens, consisting of the seven natural language tokens: “How”, “to”, “bake”, “a”, “cake”, “without”, “eggs”.

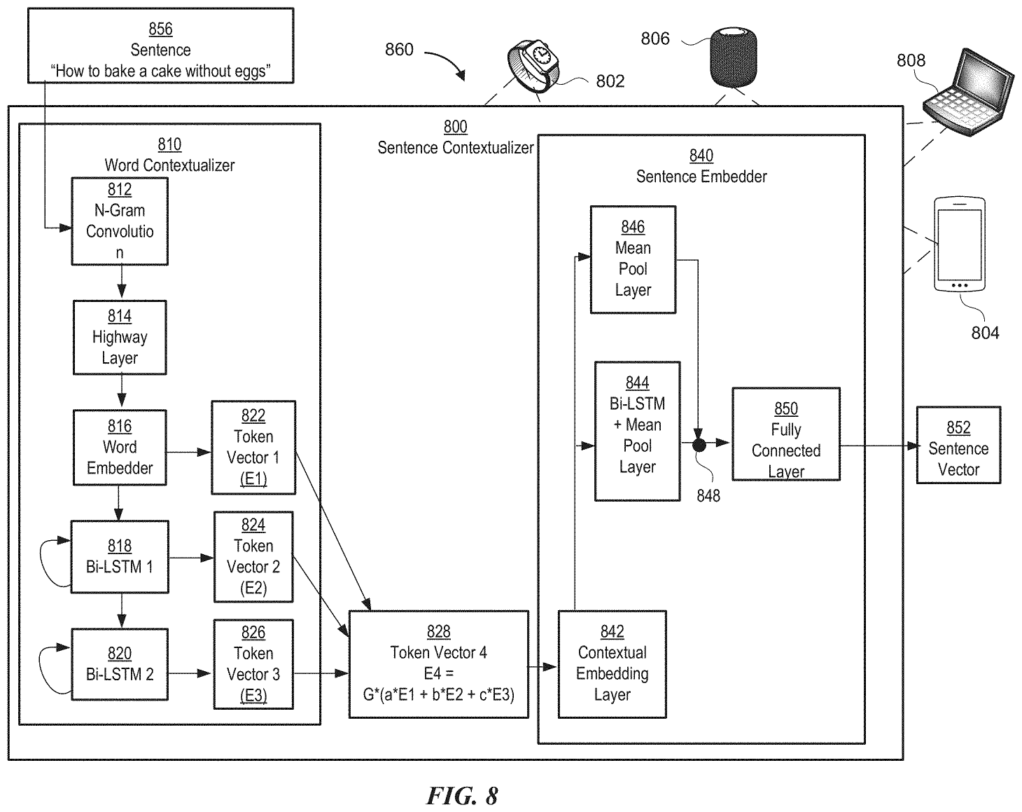

The various embodiments are directed towards embedding a sentence (or natural language object) within a vector space of a language model. More specifically, the embodiments may employ two separate language models, arranged in a serial architecture (See FIG. 8), to generate a vector (e.g., a sentence vector) for a received sentence that is employed as an input to the architecture. The first language model generates token vectors for each of the tokens of the received sentence in a vector space of the first model. The token vectors and/or the received sentence are employed as inputs to the second language model. The second language model generates the sentence vector for the sentence. The sentence vector is embedded in a vector space of the second language model. Thus, a sentence vector (generated from an input sentence) may be said to embed the sentence in the vector space of the language model. The sentence vector may also be said to embed the semantic context of the corresponding sentence within the vector space. Accordingly, the first language model may be referred to as a token (or word) embedding model, while the second language model may be referred to as a sentence embedding model.

The term “sentence vector” is used throughout to refer to an embedding of a generalized natural language object (also referred to as a sentence herein) of an arbitrary length. It is understood that the qualifier “sentence” in the term “sentence vector” is non-limiting, and a sentence vector may be a vector embedding of a sentence, sentence fragment, question, answer, statement, phrase, clause, stanza, lyric, title of an artistic work, or any other natural language object of an arbitrary length (e.g., the value of n in the object's n-gram encoding is any positive integer). The vector space may be an m-dimensional manifold (e.g., a linear manifold), where the value of m is a positive integer that indicates the dimensionality of the sentence vector, as dictated by the language models. In some non-limiting embodiments, and depending on the architecture of the sentence embedding model, m may take on the value of 512. One or more metrics may be defined for the vector space, such as cosine similarity, cosine distance, Euclidean distance, Manhattan distance, and the like. Such metrics may each be referred to as a distance and/or similarity metrics.

The embedding of a sentence may be a deeply contextual embedding. That is, the value for the components of the sentence vector (corresponding to a sentence) encode “deeply learned” contextual features of the sentence. Such a sentence embedding may be employed in various natural language processing (NLP) applications and/or scenarios. The vector embeddings of the embodiments may be employed in virtually any NLP application that employs a semantic concept (e.g., a meaning, idea, concept, statement, or the like) corresponding to a natural language input (e.g., a sentence). In the various embodiments, a correspondence between the semantic context of a sentence and its vector embedding (e.g., a sentence vector-to-semantic context mapping) may be determined. Accordingly, a sentence may be embedded, and one or more semantic contexts of the sentence may be determined via a sentence vector-to-semantic context mapping. Furthermore, the embodiments may be employed in any NLP application that may associate two natural language sentences, based on one or more semantic relationships between the semantic contexts of the two sentences. For such embodiments, a semantic relationship between two sentences may be determined and/or inferred via one or more spatial relationships of their embeddings. A spatial relationship-to-semantic relationship mapping may be determined for such embodiments. Various means may be employed to determine and/or learn such mappings between sentence vectors and semantics of the sentences, e.g., sentence vector-to-semantic context mappings and spatial relationship-to-semantic relationship mappings. For example, (supervised and/or unsupervised) machine learning may be employed to determine such vector mappings.

In at least one embodiment, a user may provide, to a computing system, a phrase (e.g., spoken or text-based) that is intended to relay an executable command to an input mechanism of the system (e.g., a voice-activated digital assistant or a command prompt). The phrase may be a paraphrasing of the intended executable command, and is not itself executable (e.g., the phrase is not recognized by the system). Prior to receiving the phrase, various recognized (and executable) commands may be embedded in the vector space. Upon receiving an unrecognized phrase, a sentence embedding of the unrecognized phrase may be generated.

Based on spatial relationships between the sentence embedding of the unrecognized phrase and sentence embeddings of each of the recognized commands, as well as correspondences between these spatial relationships and the semantic contexts of the sentences, the intended (and executable) command may be determined. That is, a spatial relationship-to-semantic relationship mapping may be employed to identify and select the intended command from the recognized commands. The intended command may be executed by the system. Accordingly, the user experience of the system is enhanced. As noted above, due to the contextual nature of the embeddings, such correspondences for the semantic relationships between sentences and the spatial relationships between their sentence embeddings may be determined and/or learned via various mechanisms. For example, supervised and/or unsupervised machine learning methods may be employed to determine such sentence vector-to-semantic mappings.

The sentence embeddings may be used in any application where determining the semantic context of a sentence is useful and/or where determining associations between two (or more) sentences, based on a semantic relationship between their semantic contexts, are useful. For example, sentence embeddings may be employed to increase the performance of search engines, natural language translation applications, and the like. In at least one embodiment, a user may be recommended one or more frequently asked questions (FAQs). Many applications, websites, and other information systems include FAQ content. In such systems, a user may manually search for a frequently asked question, and find a corresponding answer. In the embodiments, a user may be enabled to provide their, via spoken or text-based mechanisms. Their question may be a paraphrasing of a question in the FAQ content. Traditional search engines may not match the user's paraphrasing of the included questions. However, via sentence embeddings, the user's question may be automatically matched to a semantically similar, and thus relevant, question included in the content. Thus, the user may be automatically provided the corresponding answer to their paraphrased question.

In still other scenarios, the embodiments may be employed to pair content (e.g., electronic messages, files, internet bookmarks, reminders for tasks and/or events, and the like) with content collections (e.g., folders and/or lists that that organize the content). For example, if new content is received (e.g., a new email message), the vector embeddings of sentences included in the new message may be compared to the vector embeddings of sentences in the messages already sorted by and/or stored in the available message folders. One or more folders that store semantically similar messages may be recommended to the user for storing their newly received message. Such embodiments may be used to recommend folders for files (e.g., in a file system), folders to store internet bookmarks (e.g., in a web browser), lists to include a reminder for a task and/or event (e.g., in a reminders or to-do list application), and the like.

Still other embodiments may pair content in other ways based on sentence embeddings. For instance, a user may provide a sentence, e.g., “You're beautiful.” A content database may be searched to return content that includes a semantic context that is similar to the input sentence, via sentence embeddings of the inputted sentence and sentences associated with the content. Such content may include poetry, works of literature, music lyrics, captions (or other descriptive text) for images, and the like. Such similar content may be returned to the user based on matches between the sentence embeddings. One or more images, poems, novels, songs, or the like may be returned based on matching the sentence embeddings. In the above example, where the user input the sentence “You're beautiful,” Sonnet 18 by William Shakespeare (e.g., a poem), an image of the user's spouse, or a love song may be returned to the user.

Other embodiments pair various types of content to generate multimedia presentations of the paired content. In one non-limiting embodiment, images and music may be paired based on sentence embeddings. The pairings of an image and a song may be presented such that the image is displayed on a device's display, while the device plays the song. For example, one or more sentences included in a caption (or other descriptive text) for one or more images may be embedded in the vector space. Additionally, sentences included in the lyrics for one or more songs may be embedded in the vector space. Associations between the sentence embedding may be determined to pair images with songs with lyrics that are semantically similar to text describing the image (e.g., a caption for the image). In some embodiments, multimedia slide shows and/or slide decks may be automatically generated by the various embodiments.

In some embodiments, machine learning may be employed to automatically generate one or more textual descriptions of an image. An image classifier may be trained to automatically generate text describing various semantic contexts of an image. For example, an image classifier may be trained to automatically generate text describing a scene and/or object depicted in the image. Sentences embeddings of one or more sentences included automatically and/or manually generated text describing an image may be generated. When the sentence embeddings are associated with an image, such sentence embeddings may be employed in various scenarios, e.g., to enhance to performance of image search engines, the above pairings between music and images, and the like.

In some embodiments, the word embedding language model (e.g., the first language model) may be a pre-trained word (or token) embedding model. In some embodiments, the word embedding model may be a contextual word embedding model. That is, the word embedding model may employ one or more recurrent neural networks (RNNs) that include internal state memory such that each token (or word) vector is generated in the context of one or more other tokens (or words) included in the sentence. Thus, the word embeddings of the word embedding model are semantic contextual word embeddings. In at least one embodiment, the word embedding model is a pre-trained Embeddings from Language Models (ELMo) model. Other embodiments are not so constrained, and may employ other word embedding models as the first language model.

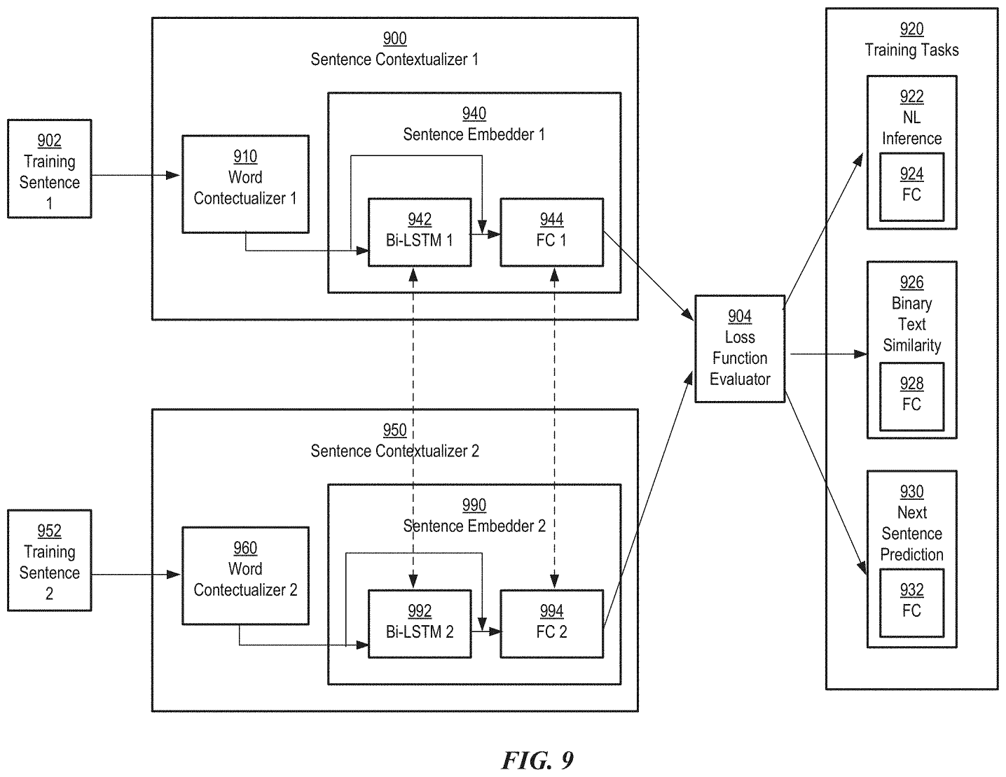

As discussed in conjunction with at least FIG. 9, the sentence embedding model (e.g., the sentence embedding model) may be trained over multiple semantic tasks, such that the sentence vectors (which are dependent on the contextual token vectors) encode features (e.g., latent and/or hidden features) of the sentence relating to the semantic context (e.g., the meaning, idea, concept, or the like) of the sentence. Various deep learning supervised methodologies may be employed when training the second language model (e.g., multitask supervised learning). When training the sentence embedding model, pairs of training sentences may be employed. The pairs of training sentences may be labeled with one or more semantic relationships. The sentence embedding model may be trained to generate sentence embeddings that are consistent with the semantic relationships of the pairs of training sentences. As also discussed, each of the tasks of the multitask training may be directed towards one or more types of semantic relationships (e.g., semantic similarity, semantic inference, next sentence prediction, and the like).

As a consequence of the multitask training of the sentence embedding model, a sentence vector may be employed to infer and/or determine meaningful features of the semantic context of the corresponding sentence. More specifically, a sentence vector corresponding to a sentence may be employed to infer and/or determine the semantic context (e.g., meaning) of the sentence, via a locality (or position) of the sentence vector within the vector space. For example, a particular finite volume of the vector space may be associated with a particular semantic context. If the sentence vector is located in (or near) the particular volume, then the semantic context of the natural language object may be determined to be (or be related to) the particular semantic context.

Such mapping of regions of the vector space to semantic contexts may be accomplished via various means. Some embodiments employ supervised deep learning methods. For instance, a sentence vector-to-semantic context mapping may be generated via the sentence embeddings of training sentences. After the sentence embedding model is trained, sentence vectors for training sentences labeled with one or more ground-truth semantic contexts may be generated. The sentence vectors and the ground-truth labels may be used as input to the semantic classifier model being trained. That is, the sentence embeddings of the training sentences, as well as the ground-truth labeling the semantic contexts of the corresponding training sentences, may be employed to train a semantic classifier model, via deep supervised learning. The training sentences employed for training the semantic classifier model may be separate sentences from the training sentence pairs employed to train the sentence embedding model. The trained semantic classifier model may classify new sentences with one or more of the semantic contexts used in training of the semantic classifier model. Accordingly, a semantic context classifier model may be trained for any applicable semantic context.

In other embodiments, the sentence vector-to-semantic mapping between sentence vectors and the semantic context of the corresponding sentence may be generated, via unsupervised learning methods. Such unsupervised learning methods may include, but are not limited to, identifying clusters of sentence embeddings in the vector space of the sentence embedding model. In such embodiments, sentence embeddings of a plurality of unlabeled training sentences (e.g., training sentences not used to train the second model) may be generated. Due to the multitask training of the sentence embedding model, the training sentence vectors may naturally form a plurality of clusters in the vector space. Because the clusters include sentence vectors, such clusters may be referred to as sentence clusters. The clusters may be identified and/or determined, via one or more unsupervised clustering methods. Such clustering methods may include, but are not limited to, partitioning methods (e.g., k-means), hierarchical methods, fuzzy clustering methods, density-based clustering methods, model-based clustering methods, and the like. A centroid and/or at least an approximate boundary (within the vector space) may be determined to define each cluster. Each cluster may correspond to one or more semantic contexts based on the sentences that clustered together. A cluster-to-semantic context mapping may be determined by one or more various methods, such as but not limited to (supervised or unsupervised machine learning), manual and/or automated annotation to generate a lookup table, or the like. The cluster-to-semantic relationship mapping may be encoded in a 1D lookup table. The semantic context of a new sentence may be determined via embedding the cluster in the vector space and determining if the sentence embedding is within or near a known cluster.

In some embodiments, semantic relationships between the semantic contexts of two or more sentences may be determined via various methods. A semantic relationship between two sentences (or their corresponding vector embeddings) may include one or more classifications and/or characterizations of a semantically-meaningful relationship between the two sentences. That is, a semantic relationship may indicate one or more classifications and/or characterizations of meaning, concept, or the like that provides a link or transition between a pair of sentences. Some non-limiting examples of a semantic relationship include whether the semantic contexts of the two sentences are textually similar or dissimilar. For instance, if the second sentence is a paraphrasing (or a near paraphrasing) of the first sentence, a semantic relationship between the semantic contexts of the two sentences may be indicated as similar. A classification of dissimilar may be applied to the semantic relationship between two sentences that are not linkable as similar. For instance, the semantic relationship between the vector embeddings of a first sentence: “A man and a woman are driving the down the street in a jeep” and a second sentence: “A man and a woman are driving down the road in an open vehicle” may indicate that the semantic contexts (e.g., meaning) of the two sentences are similar. For such semantically similar sentences, the second sentence may be a paraphrasing of the first sentence As another example, the semantic relationship between a third sentence: “A man is talking and a woman is talking” and a fourth sentence: “A woman is dancing” may indicate that the semantic contexts of the two sentences are dissimilar.

Another semantic relationship between a pair of two sentences may indicate whether if, in the context of the natural language, the second sentence could contextually follow the first object (or vice versa). For example, if a second sentence is placed after a first sentence, the semantic relationship may indicate whether or not a reading of the two sentences (in that order) make semantic sense in the context of the natural language (e.g., next sentence prediction). Still another semantic relationship between a pair of two sentences may indicate an inferential logical relationship between the semantic contexts. That is, the semantic relationship may indicate whether a truth (or a falsity) of the second sentence logically follows from an assumption of the truth (or falsity) of the first sentence (e.g., whether an entailment relationship exists between the two sentences), whether the semantic contexts of the objects are in contradiction to one another (e.g., the semantic contexts of the sentences are in contradiction), or whether the semantic contexts of the two objects are not logically related (e.g., the two sentences have a neutral semantic relationship). Note that there may exist more than one semantic relationship between two paired sentences. Various other semantic relationships between natural objects may be included in the various embodiments.

In the various embodiments, due to the multitask semantic training of the sentence embedding model, a semantic relationship between the semantic contexts of two sentences may be determined and/or inferred based on a spatial relationship between the two corresponding sentence vectors. Such a spatial relationship may include the absolute and/or relative positions of each of the sentence vectors in the vector space, as well one or more distance metrics defined over the vector space. Such distance metrics may include, but are not limited to, Euclidean distance, Manhattan distance, Minkowski distance, Chebyshev distance, cosine distance, or any other such distance metric. The spatial relationship between the two sentence vector may be based on various vector operations on the two vectors, such as but not limited to vector inner products, vector outer products, vector cross products, vector addition, vector subtraction, cosine similarity, and the like.

Various methods may be employed to generate a spatial relationship-to-semantic relationship mapping between two sentence vectors (corresponding to two sentences representing two or more semantic contexts). In some embodiments, supervised deep learning may be employed to determine a spatial relationship-to-semantic relationship may be determined. A non-limiting example of such embodiments, include training a semantic relationship classifier model via deep learning. Such embodiments may be implemented in a similar fashion to those discussed above with respect to generating the sentence vector-to-semantic context mapping, by employing paired sentences with known semantic relationships as training data. Briefly, a semantic relationship classifier model may be trained by embedding pairs of training sentences in the vector space. The pairs of training sentences may be labeled with a ground-truth indicating their semantic relationship. The semantic relationship classifier model may be trained by inputting the pairs of sentence vectors and the corresponding semantic relationship labels into the training. Thus, a semantic relationship classifier model may be trained to determine a spatial relationship-to-semantic relationship mapping for pairs of sentences. That is, the semantic relationship classifier model may receive two sentence vectors (or the two corresponding sentences and then employ the first and second language models to generate the two sentence vectors), and determine and/or classify one or more semantic relationships between the two sentences based on a spatial relationship between the two vectors. Accordingly, a semantic relationship classifier model may be trained for any applicable semantic relationship. A classifier may be trained for virtually any applicable training relationship.

In other embodiments, unsupervised clustering methods may be employed to generate a spatial relationship-to-semantic relationship mapping. Such clustering methods may be similar to those discussed above in generating a sentence vector-to-semantic context via clustering methods. One or more semantic relationships may be determined from one or more clusters that each of the sentence vectors are associated with. For instance, if the first sentence is associated with a first sentence cluster and the second sentence is associated with a second sentence cluster, a first semantic relationship may be determined for the first and second corresponding sentences. If both of a third and a fourth sentence vectors are associated with a third sentence cluster, a second semantic relationship between the corresponding third and fourth sentences. A cluster-to-semantic relationship mapping may be generated via various methods, such as but not limited to machine learning, manual and/or automated annotation, and the like. A cluster-to-semantic relationship mapping may map two separate clusters to a semantic relationship, and thus may be encoded a 2D lookup table.

In at least one embodiment, the two semantic contexts of the two sentences may be directly mapped to a semantic relationship. In such embodiments, the semantic context of each of the two sentences may be determined as discussed above, and the semantic relationship may be based on each of the semantic contexts. Such a mapping may be determined via various methods, such as but not limited to machine learning, manual and/or automated annotation, and the like.

Turning attention to FIG. 8, FIG. 8 illustrates an environment 860 for generating a sentence embedding for an inputted sentence, according to various embodiments. Environment 860 may include one or more electronic devices, such as but not limited to a smartwatch 802, a smartphone (and/or tablet device) 804, a smartspeaker 806, a laptop device 808, and the like. One or more of such devices 802-808 may be collectively referred to, interchangeably, as electronic devices, computing devices, devices, computers, or the like. Each of the devices 802-808 may be enabled to implement one or more instances of a digital assistant (which may be interchangeably referred to as a virtual assistant), as described throughout. Furthermore, each of devices 802-808 may be enabled to implement sentence contextualizer 800. Sentence contextualizer 800 may be an application, module, engine, or another component implementable by each of devices 802-808, one or more applications installed on any of devices 802-808, and/or one or more services (e.g., software as a service) accessible via one or more wired and/or wireless communication networks. FIG. 8 is not intended to be exhaustive, and other computing devices not shown in FIG. 8 (desktop computing devices, virtual reality (VR) devices, augmented reality (AR) devices, and the like) may be included in environment 800 and/or may implement a digital assistant and/or sentence contextualizer 800.

As shown in FIG. 8, sentence contextualizer receives, as input, a sentence 856 (e.g., a natural language object). In the non-limiting example of FIG. 8, the input sentence 856 is “How to bake a cake without eggs”. For sentence contextualizer to process the input sentence 856, the input sentence 856 may be encoded in an n-gram (e.g., (“How”, “to”, “bake”, “a”, “cake”, “without”, “eggs”)). Note that the n-gram includes an ordered set of natural language tokens. Sentence contextualizer 800 employs two separate language models, arranged in a serial architecture, to generate a sentence vector 852. The word contextualizer 810 may implement a first natural language model (e.g., a word (or token) embedding model). Outputs of the first language model (e.g., token vector 4 828) are provided to the sentence embedder 840. Sentence embedder 840 may implement a second natural language model (e.g., a sentence embedder model) to generate sentence vector 852, as output of the sentence contextualizer 800. Thus, sentence vector 852 may be a vector in the vector space of the second language model. In some non-limiting embodiments, sentence vector is a 512-dimensional vector. As discussed throughout, the sentence vector 852 is a vector embedding of sentence 856. That is, sentence vector 852 embeds the semantic context (e.g., the meaning, idea, concept, statement, or the like) of sentence 856 in the vector space of the second language model.

Word contextualizer 810 may implement the first language model (e.g., the word embedding model), via one or more trained neural networks. Sentence embedder 820 may implement a second language model (e.g., the sentence embedding model) via one or more additional trained neural networks. More specifically, word contextualizer 810 receives the n-gram encoding sentence 856. The first language model (as implemented by word contextualizer 810) may be employed to embed each token included in the n-gram in one or more token (or word) embeddings. That is, the first language model embeds each token in a vector space of the first model. The token vectors for each token are received by sentence embedder 820. Based on these inputs, the second language model (as implemented by sentence embedder 820) generates sentence vector 852. As discussed below, via sentence vector 852 and the training of the first and second language models, the semantic context of sentence 856 is embedded in the vector space of the second language model. Note that the vector space of the first language model need not be the same vector space of the second language model.

In some embodiments, the first language model may be trained to generate token (or word) vectors (e.g., word representations) that model both the complex characteristics of how the word is used in sentence 856, as well as how the uses of the word vary across linguistic contexts. As used throughout, the terms “token” and “word” may be used interchangeable to represent any object in the input n-gram. Via the use of one or more recurrent neural networks (RNNs), the embedding (e.g., the vector representation) of each word included in sentence is dependent on each other word (or token) included in the sentence 856, as well as the order of the words (or tokens) in sentence 856. That is, the token vector (or word vector) representation of each word in sentence 856 is dependent upon the semantic context of sentence 856, as well as the semantic use of the word in the sentence 856 and the semantic use of each of the other words in the sentence 856. Because the first language model may take into account the semantic context of the sentence 856, as well as the semantic context of each word in the sentence 856, the first language model may be said to generate deep contextualized representations (e.g., token vectors) for each word (or token) in an input sentence. Because the first language model generates a token vector for each word or token included in the input sentence 856, the first language model may be referred to as a word embedding model. Furthermore, because the contextual use of each word is employed to generate the token vectors, the first language model may be a contextual word embedding model.

In at least one non-limiting embodiment, the first language model may be an Embeddings from Language Models (ELMo) model. In such embodiments, the ELMo model (as employed as the first language model) may be pre-trained, and thus its training is not discussed herein. One non-limiting architecture for implementing such an ELMo model is shown in FIG. 8. To implement the ELMo model, word contextualizer 810 may include one or more neural networks and/or one or more network layers. In the embodiment shown in FIG. 8, the ELMo model is implemented via an n-gram convolution network 812, a highway layer 814, a word embedder network 816, and two Bi-directional long short term memory (Bi-LSTM) networks: Bi-LSTM 1 818 and Bi-LSTM 2 820. Note that word embedder 816 generates a first token vector (i.e., E1 822) for each token. The first embedding of the token is fed into Bi-LSTM 1 818 to generate a second vector embedding (i.e., E2 824) for the token. The second embedding of the token is fed into Bi-LSTM 2 820 to generate a third embedding of the token (i.e., E3 826). The recurrent (or feedback nature) of the Bi-LSTMs 818/820 is shown via the loops in the networks. The Bi-LSTMs 818/820 at least partially enable the contextual aspects of the contextual word embedding model.

In some embodiments, a linear (or scalar) combination of the three token vectors for each token may be taken to generate a fourth token vector (E4 828) for each of the tokens in the input sentence 856. In a non-limiting embodiment, E4=G*(a*E1+b*E2+c*E3). Thus, in the embodiment of FIG. 8, an ordered set of seven separate E4s 828 are provided to the sentence embedder 840, e.g., one token vector for each of the seven tokens: “how”, “to”, “bake”, “a”, “cake”, “without”, and “eggs”. In at least one embodiments, the original non-embedded n-gram may be additionally provided to sentence embedder 840. As noted above, the ELMo model may be pre-trained, but in some embodiments, the scaling factor (i.e., G) and the linear weights (i.e., a, b, and c) may be adjusted (or learned during training) to enhance performance, based on the application or use case of the word embedding.

Sentence embedder 840 implements a second language model (e.g., a sentence embedding model) that receives as input a token vector 4 828 (e.g., E4) for each token included in the sentence 856. As noted above, in some embodiments, sentence embedder 840 may additionally receive the n-gram encoding sentence 856 as input. To implement the second language model, sentence embedder 840 may include one or more neural networks and/or one or more network layers. In the embodiment shown in FIG. 8, the second language model is implemented via a contextual embedding layer 842, a network that includes an RNN and Mean pooling layer (i.e., Bi-LSTM+Mean Pool Layer 844), another mean pooling layer 846 and a fully connected layer 850. The vectors resulting from the Bi-LSTM and mean pooling layer network 844 and the mean pooling layer 846 may be concatenated at node 848, prior to being fed forward to the fully connected layer 850. Fully connected layer 850 generates the final sentence vector 852. Because the second language model generates a sentence vector, the second language model may be referred to as a sentence embedding language model. The second language model may be trained, via one or more machine learning (ML) models, such as but not limited to a supervised ML method employing training data that is labeled with ground truths. In some embodiments, the sentence embedding model may be trained, via multitask learning, as discussed in conjunction with FIG. 9.

FIG. 9 illustrates an example of multitask training for a sentence embedding language model, according to various embodiments. That is, one or more tasks of a plurality of semantic-related tasks may be employed to train the sentence embedding model. Such semantic tasks may include one or more semantic context tasks and/or one or more semantic relationship tasks, as discussed above. For each task of the plurality of semantic (or language) tasks, a separate training corpus may be employed. A training corpus for a particular task may include a plurality of pairs of sentences. Each pair of sentences may be labeled with a ground-truth semantic relationship between the pairs. Thus, the paired and labeled sentences may be referred to as training sentences. The labeled semantic relationship between the pair is dependent upon the particular task that the pair is employed for training purposes. The training process includes employing one or more machine learning (ML) methods or algorithms, such as but not limited to supervised ML methods. A supervised ML method may include iterative performing training tasks (e.g., by employing the labeled training data) and determining how well the model performed during each iteration by comparing the model's predicted “answer” and the ground-truth, as indicated by the labels in the training data. The model's performance may be determined based on a loss function, which is based on a comparison between the ground truth and the model's prediction for the answer. The model's parameters and/or weights may be iteratively adjusted to minimize (or at least decrease) the loss function. Thus, the supervised ML methods may include algorithms for, or similar to, backpropagation, gradient descent, and the like. During the iterative process of multitask training, the training may alternate through the plurality of tasks in a round-robin fashion. In this way, the model is simultaneously optimized to perform multiple predictive tasks. Thus, by training the second language model (e.g., the sentence embedding model implemented by sentence embedder 840 of FIG. 8), it may be said that the model is trained to generate useful sentence embeddings in a vector space. The vector space spans features (e.g., hidden and/or latent features) of a sentence that are useful in determining a semantic context of the sentence, as well as semantic relationships to other sentences.

In the non-limiting embodiment of FIG. 9, three separate sentence classification tasks are employed in the multitask training. The three tasks may be semantic relationship-related tasks. In this embodiment, the three tasks include: a natural language inference task, a semantic text similarity task, and a next sentence prediction task. In other embodiments, more of fewer tasks may be employed. Alternative semantic or language tasks may be employed in other embodiments. Each task in this embodiment is directed towards classifying a semantic relationship between a pair of sentences, where the nature (e.g., classification labels) of the semantic relationship is dependent on the nature of the task. Because each task is a classification task, known embodiments for training a classifier may be employed. In such embodiments, the second language model is being trained such that a spatial relationship of the vector embeddings of two sentences may indicate and/or correspond to one or more semantic relationships between the two sentences. As the training converges on successfully predicting the semantic relationship between pairs of training sentences, vector embeddings of other sentences indicate features that are useful to determine various semantic contexts of the embedded sentences.

The first semantic training task includes a natural language inference task, where the goal is to learn to label an inference semantic relationship between an ordered pair of sentences, based on a spatial relationship between the corresponding vector embeddings. For this task, the inference semantic relationship may be classified as one of three possible classifications: entailment, contradiction, and neutral. The training corpus for the natural language inference task may include a plurality of ordered pairs of sentences, where each pair is labeled with a ground truth comprising of: entailment, contradiction, and neutral. The first sentence in the ordered pair may be referred to as the premise of the pair and the second sentence may be referred to as the hypothesis of pair. During training, the sentence embedding model learns to embed the sentences such that the spatial relationship between the two sentence vectors indicate (or at least approximately indicate with a high degree of likelihood) the correct classification of the inference semantic relationship between a pair of sentences as one of: entailment, contradiction, or neutral.

For a pair with a semantic relationship labeled as entailment, the semantic context of the hypothesis is consistent with the semantic context of the premise. As discussed above, for a pair of sentences in an entailment semantic relationship, the semantic context of the hypothesis may be inferred to be true, if the semantic context of the premise is assumed true. For a pair of sentences in a contradictory semantic relationship, the semantic context of the hypothesis may be in contradiction to the semantic context of the premise. That is, the semantic context of the hypothesis may be inferred to be false, if the semantic context of the premise is assumed true. For a pair of sentences in a neutral semantic relationship, the truth or non-truth of the semantic context of the hypothesis cannot be inferred from the semantic context of the premise. An ordered pair of training sentences with the ground-truth label of entailment (for the natural language inference task) may include (“A soccer game with multiple males playing”, “Some men are playing a sport”). An ordered pair of training sentences with the ground-truth label of contradiction may include (“A man inspects the uniform of a figure in some East Asian country”, “The man is sleeping”). An ordered pair of training sentences with the ground-truth label of contradiction may include (“An older and younger man smiling”, “Two men are smiling and laughing at the cats playing on the floor”).

A second semantic training task includes a semantic text similarity task, where the goal is to learn to label a similarity semantic relationship between an ordered pair of sentences, based on a spatial relationship between the corresponding vector embeddings. For this task, the similarity semantic relationship may be classified as a binary: true or false. A true similarity semantic relationship indicates that the semantic context of the hypothesis is similar to the semantic context of the premise. That is, the premise and hypothesis may be paraphrasings of one another. A false similarity semantic relationship indicates that the semantic context of the hypothesis is not similar to the semantic context of the premise. Thus, the training corpus for the natural language inference task may include a plurality of ordered pairs of sentences, where each pair is labeled with a ground truth comprising of: true or false. During training, the sentence embedding model learns to correctly classify the similarity semantic relationship between a pair of sentences as one of: true or false. An ordered pair of training sentences with the ground-truth label of true (for the semantic text similarity task) may include (“A man and woman are driving down the street in a jeep”, “A man and a woman are driving down the road in an open air vehicle”). An ordered pair of training sentences with the ground-truth label of false may include (“A man is talking”, “A woman is dancing”).

A third semantic training task includes a semantic “next sentence prediction” task, where the goal is to learn to label a predictive semantic relationship between an ordered pair of sentences, based on a spatial relationship between the corresponding vector embeddings. For this task, the predictive semantic relationship may be classified as a binary: true or false. A true prediction semantic relationship indicates that the semantic context of the hypothesis may follow from the semantic context of the premise. That is, the semantic context of the hypothesis may be a natural follow up to the semantic context of the premise. Stated another way, for a true prediction semantic relationship, the semantic context for the hypothesis and premise are semantically related such that the hypothesis may be read directly after the premise, without the need for a one or more transitional sentences between the premise and the hypothesis. A false prediction semantic relationship indicates that the semantic context of the hypothesis does not follow from the semantic context of the premise, without one or more transitional sentences. Thus, the training corpus for the natural language inference task may include a plurality of ordered pairs of sentences, where each pair is labeled with a ground truth comprising of: true or false. During training, the sentence embedding model learns to correctly classify the prediction semantic relationship between a pair of sentences as one of: true or false. An ordered pair of training sentences with the ground-truth label of true (for the next sentence prediction task) may include (“Fields held her position as a Vice President at Universal until her death in 1982”, “Jaws was the last film that she edited”). An ordered pair of training sentences with the ground-truth label of false may include (“Fields held her position as a Vice President at Universal until her death in 1982”, “The Sun's report said that City had cruised to victory”).

Returning to FIG. 9, when training the sentence embedding language model (e.g., implemented by sentence contextualizer 800 of FIG. 8), vector embeddings of ordered pairs of training sentences are generated. In some embodiments, a sentence vector for training sentence 1 902 is generated via the sentence contextualizer under training (e.g., sentence contextualizer 1 902). A sentence vector for training sentence 2 952 is also generated. Training sentences 1/2 902/952 are an ordered pair of sentences labeled with a semantic relationship corresponding to one of the plurality of semantic training tasks. In FIG. 9, two copies of a sentence contextualizer are shown: sentence contextualizer 1 900 and sentence contextualizer 2 950 are shown. Each of these sentence contextualizers may be similar to sentence contextualizer 800 of FIG. 8. Training sentence 1 902 is employed as an input to sentence contextualizer 1 900 and training sentence 2 is employed as an input to sentence contextualizer 2 950. In some embodiments, the two sentence contextualizer are separate copies of the sentence contextualizer under training. In other embodiments, a single copy of the sentence contextualizer is used, but it is shown as two separate sentence contextualizers in FIG. 9 for clarity.

Whether a single copy or two copies are employed, as noted above, each of sentence contextualizer 1 900 and sentence contextualizer 2 950 may be similar to sentence contextualizer 800. For clarity, the following discussion assumes two separate copies of the sentence contextualizer, wherein each copy is iteratively updated during training. Similar to sentence contextualizer 800 of FIG. 8, sentence contextualizer 1 900 includes a word contextualizer 1 910 and sentence embedder 1 940, while sentence contextualizer 2 950 includes word contextualizer 2 960 and sentence embedder 2 990. For purposes of clarity, a simpler architecture for the two sentence embedders is shown in FIG. 9. Sentence embedder 1 940 includes Bi-LSTM 1 942 and fully connected (FC) layer 1 944. Sentence embedder 2 990 includes Bi-LSTM 2 992 and fully connected (FC) layer 2 994. Note that the mean-pool layer 846 included in FIG. 8 is omitted in both sentence embedders 940 and 990, however such neural network layers may be included in the embodiments of FIG. 9

The loss function evaluator 904 evaluates the loss function. The loss function compares the model's prediction for each task with the labeled ground truths. The nature of the loss function may vary across tasks. In some embodiments, a single lost function is used for all the training tasks. In other embodiments, a separate loss function is employed for each of the training tasks. In some embodiments, a different FC layer is employed for each of the separate training tasks. The training tasks 920 are illustrated to include the natural language task 922 (and its associated FC 924), the binary text similarity task 926 (and its FC 928), and next sentence prediction task 930 (and its FC 932). FIG. 9 illustrates the parameters and/or weights of the various FCs being updated based on the evaluations of the loss function. The hashed lines between Bi-LSTM 1 942 and Bi-LSTM 2 992, as well as between FC 1 944 and FC 2 994, indicate that parameters and/or weights may be shared across the tasks.

### 5. Use Cases for Sentence Embeddings

Various methods for generating sentence embeddings and employing those sentence embeddings in various use cases are discussed below. In some embodiments, a first sentence may be received, and a second sentence is selected from a corpus of sentences (e.g., a plurality of other sentences). For example, the first sentence may be received from a user (e.g., a user provides a natural language spoken utterance or types a phrase into a text-based input mechanism). In some embodiments, the first sentence may be included content, in an electronic message, file, website, a caption for (or other texts describing) an image, an indication (or reminder) for an upcoming event and/or task, music lyrics, literature, works of art, or the like. Note that the corpus of sentences may be employed as a database or collection of reference sentences, of which the received first sentence may be compared to for reference. Thus, the corpus of sentences may be referred to as reference sentences and/or a plurality of other sentences. The reference sentences may be included in various content, such as but not limited one or more collections (or sub-collections) of electronic messages, files, websites, captions images, indications for upcoming events and/or tasks, music lyrics, literature, works of art, or the like. The corpus of sentences may include an identifier for an identifier for a folder of a plurality of folders, for a list of a plurality of lists, a cluster of a plurality of sentence clusters, a song, a poem, a work if art or literature, and the like.

As noted above, a second sentence (from the corpus of sentences) may be selected, in view of the first sentence. In some embodiments, the selection of the second sentence may be based on one or more of a semantic context of the first sentence, a target semantic context, a semantic relationship between the first and second sentences, and/or a target semantic relationship. More specifically, selecting the second sentence from the corpus of sentences may be based on the first sentence vector (i.e., a sentence embedding of the first sentence). In some non-limiting embodiments, the sentence embedding of the first statement may be compared with the vector embeddings of the sentences included in the corpus of sentences. Thus, a corpus of vectors sentences (e.g., a database of reference sentence vectors and/or a plurality of other sentence vectors) may be searched to identify and/or select the second sentence. In some embodiments, a mapping (e.g., a lookup table) between the sentences of the sentence corpus and the sentence vectors of the sentence vector corpus may be stored and consulted when translating between sentences and their corresponding sentence embeddings. In some embodiments, a sentence context for each sentence and/or sentence vector may be included in such a sentence-to-vector mapping. In at least one embodiment, a semantic relationship between pairings of sentences of the corpus of sentences may be included in the sentence-to-vector mapping. Such a sentence-to-vector mapping may be referred to as a phrase-to-vector mapping and/or correspondence.

In some embodiments, the selection of the second sentence from the corpus of sentences is based on based on at least one of: the semantic context of the first sentence (as indicated by its vector embedding), the semantic context of the second sentence, one or more target semantic contexts (e.g., a desired and/or intended semantic context employed to select the second sentence over other sentences included in the corpus of sentences), a semantic relationship between the semantic contexts of the first and second sentences (as indicated by a spatial relationship between their corresponding vector embeddings), and/or a target semantic relationship (e.g., a desired and/or intended semantic relationship between the first and second sentences employed to identify the second sentence over other sentences in corpus of sentences).

As discussed below, and depending upon the use case, one or more actions (e.g., providing content and/or associating content) may be performed. The performed actions may be based on the second sentence, the semantic contexts of the first and/or second sentences, and/or a semantic relationship between the two sentences. As discussed in more detail below, the performed actions may include associating content that includes the first sentence with other similar content (e.g., content associated with the second sentence), generating machine executable commands that are consistent with a user intent encoded in the first sentence, enhancing the performance of search engines, generating multimedia content (e.g., combinations of images and music) based on the user context of the first sentence, and translating sentences from a first language to a second language.

One non-limiting use case is deployable in search engine (e.g., an internet search engine) applications and/or platforms. In such an embodiment, a first sentence (e.g., a search phrase and/or question) may be provided as a search query to a search engine. Based on the wording of the first sentence and the capabilities of the search engine, a re-phrasing of the search query may improve the “hits” returned by the search engine. That is, if a second sentence that is semantically similar to the first sentence is employed as the search query, the performance of the search engine may be enhanced. For instance, a user may provide a question to be employed as a search query (e.g., a first sentence including “If I had to choose between learning Java and Python, what should I choose to learn first?”) to a search engine. Based on the phrasing of the user provided question, the search engine may not locate materially relevant “hits” (within its relevant search space) to the satisfaction of the user. However, the various embodiments may provide a second question (e.g., the selected second sentence) that is semantically similar to the first question (e.g., Should I learn python or Java first?”). In such cases, a target semantic relationship includes semantic similarity between the first and second sentences.

The second sentence may be selected based on its semantic context, the semantic context of the received sentence, and the target semantic relationship. The search engine may employ the second question (selected based on a target semantic relationship indicating that the second sentence should be selected such that the context of the second sentence is semantically similar to the user provided question) as the query. The search engine may have more success at locating hits in its search space to the second question (e.g., a paraphrasing of the user provided question) as compared to the user provided question. Furthermore, because the second question is selected such that the semantic contexts of the two questions are similar, the hits returned for the second question may be substantially relevant to the user provided question. Thus, the embodiments may improve the performance of a search engine.

Similar embodiments may be employed to improve the user experience with user interfaces for computing systems, such as but limited to a digital assistants and text-based user interfaces. In such embodiments, a digital assistant (or other computing service interfaces) may be enabled to recognize particular commands, queries, requests, and/or questions that are associated with a user intent (e.g., a semantic context). However, such interfaces may not enabled to recognize paraphrasings of the recognized commands, queries, requests, and/or questions that encode an equivalent and/or similar user intent.

For example, a user may intend to get a weather report from a digital assistant enabled on one of their devices, and vocalize the user intent via the latter paraphrasing above. A digital assistant may recognize the spoken question “Hey Siri, what is the weather?” but not recognize the spoken question “Hey Siri, what can I expect for the high temperature this afternoon and is it going to rain?” In such embodiments, the recognized commands, queries, requests, and/or questions may be embedded in the vector space. That is, the recognized commands may serve as a corpus of sentences and the corresponding vector embeddings may serve as the corpus of sentence vectors. If an unrecognized question (or other request) is received by the digital assistant, the received unrecognized question may be embedded in the vector space. A semantically similar recognized question may be selected based on its semantic relationship to the unrecognized question. The digital assistant may execute the recognized command. When executed, the performance of the digital assistant may achieve the intention of the user (e.g., receive a weather report), even though the user did not provide the digital assistant with a recognized command or question. Thus, the embodiments may improve the user experience when employing of a digital assistant, or any system (or a user interface for the system) that recognizes commands and/or questions, but not certain paraphrasings of those commands and/or questions.

As described throughout, still other embodiments may employ the vector embeddings for various other use cases. A corpus of sentences may be embedded in the vector space, and a clustering algorithm (e.g., an unsupervised clustering algorithm) may identify clusters of the sentences. For instance, a corpus of sentences (e.g., a plurality of other sentences) may be employed to defined sentence clusters in the vector space. At least a portion of the embedded sentences may be associated with and/or assigned to one or more clusters of a plurality of sentence clusters. For these embodiments, a novel sentence (e.g., a first sentence that is sentence not included in the corpus) may be received. Via a vector embedding of the novel sentence, the novel sentence may be associated with one or more of the sentence clusters. From the association with a sentence cluster and/or the sentences already included in the cluster, one more appropriate actions may be performed.

In such embodiments, the clusters may represent collections of data, content, and/or data structures. That is, a particular sentence cluster may correspond to a particular content collection of a plurality of content collections and/or a particular subset of a set of data structures. Thus, the plurality of sentence clusters may represent a sorting, ordering, arranging, and/or organization of content and/or data structures. Such content and/or data structures may include electronic messages, files/documents, internet bookmarks, images, audio files, lyrics to songs, captions or other text associated with an images, poems, song titles (or their associated lyrics), works of literatures, a frequently asked question (FAQ) data structure (e.g., a data structure that includes a question and one or more answers), and the like. As such, the content or set of data structures may be organized, sorted, and/or arranged via the content collections and/or subsets of data structures. Sentences included in such content and/or set of data structures may be employed as the corpus of sentences, and the corpus of sentence vectors may include the corresponding vector embeddings.

Clusters of the corpus of sentence vectors may correspond to the sorting or arranging of the content and/or set of data structures into the content collections and/or subsets of data structures. In some embodiments, each sentence cluster indicate such a content collection and/or subset of data structures. That is, a sentence cluster may indicate a file folder in a file system, a message folder for a messaging application, a folder of internet bookmarks for a web browsing application, a FAQ data structure (e.g., data that includes a question and one or more answers) for an information system, a list of upcoming tasks or events in a reminder or to-do application, and the like. The second sentence (selected from the corpus of sentences) may indicate an identifier to a particular content collection and/or a particular subset of data structures. Thus, the corpus of sentences (e.g., a plurality of other sentences) may include identifiers sentence clusters and/or their associated content or data structures. The corpus of sentences may include identifiers to files, documents, messages, reminders of upcoming events and/or tasks, song titles, poems, works of literature, images, and the like.

In some embodiment, new content (e.g., a new email message) may be automatically associated with a particular folder containing related emails via the vector embedding of sentences found in the new message and associating those sentences with one or more sentence clusters associated with the particular folder. Such embodiments may be employed to automatically sort content (e.g., electronic messages, files, internet bookmarks, event reminders for tasks, questions and the like) into content collections and/or subsets of data structures (e.g., folders, lists, FAQ data structures, and the like.

For example, a new piece of content (e.g., electronic message, internet bookmark for a website, file, an indication of an upcoming event and/or task) is received and/or accessed. The various embodiments may recommend a folder and/or list to include (or at least associate with) the new content. The selected second sentence may identify (or indicate) the subset of data structures (e.g., content collections and/or the data included in the content collections), with which the new content most closely resembles based on sentence embeddings. In some embodiments, an identifier for the particular subset of data structures (e.g., a folder) may be provided to the user. In response to receiving a selection of the identifier, the new contend may be associated with (e.g., stored in) the identified subset of data structures. In at least one embodiment, the association may be automatic, without first notifying the user.

More specifically, the first n-gram may be included in a received first electronic message (e.g., email message, instant message, text message, SMS, or the like). The received first sentence may be encoded in a first n-gram. The second n-gram (e.g., corresponding to the selected second sentence) may encode an identifier for a first folder of a plurality of message folders. The message folders may be for a messaging application installed on the electronic device. Each of the plurality of other n-grams may be included in one or more of a plurality of other electronic messages that does not include the first electronic message (e.g., the corpus of reference sentences, which includes sentences of previously received messages). A plurality of other sentence vectors (e.g., the corresponding corpus of sentence vectors) may have been generated by embedding each of the plurality of other n-grams (corresponding to the corpus of sentences) in the vector space. Each of the plurality of other electronic messages may have previously been associated with one or more folders of the plurality of message folders.

In other embodiments, the first n-gram may be included in a first website. The second n-gram encodes an identifier for a first folder of a plurality of bookmark folders for a web browsing application. The corpus of sentences includes sentences found in other websites, where a corresponding bookmark is stored in one or more of the plurality of bookmark folders. Thus, a bookmark folder (e.g., the first bookmark folder) may be provided for storing the new bookmark (a bookmark for the first website). The first website may not already have been included in the plurality of previously bookmarked websites.

In still another embodiment, the first n-gram may be included in a first reminder for an upcoming event and/or task. The second n-gram encodes an identifier for a first list of a plurality of lists for a reminder and/or to-do application. The corpus of sentences includes sentences found in other reminders for other tasks and/or events, where each other reminder is stored in one or more of the plurality of lists. Thus, a list (e.g., the first list) may be provided for storing the new reminder (e.g., the first reminder). Still other use cases are discussed below.

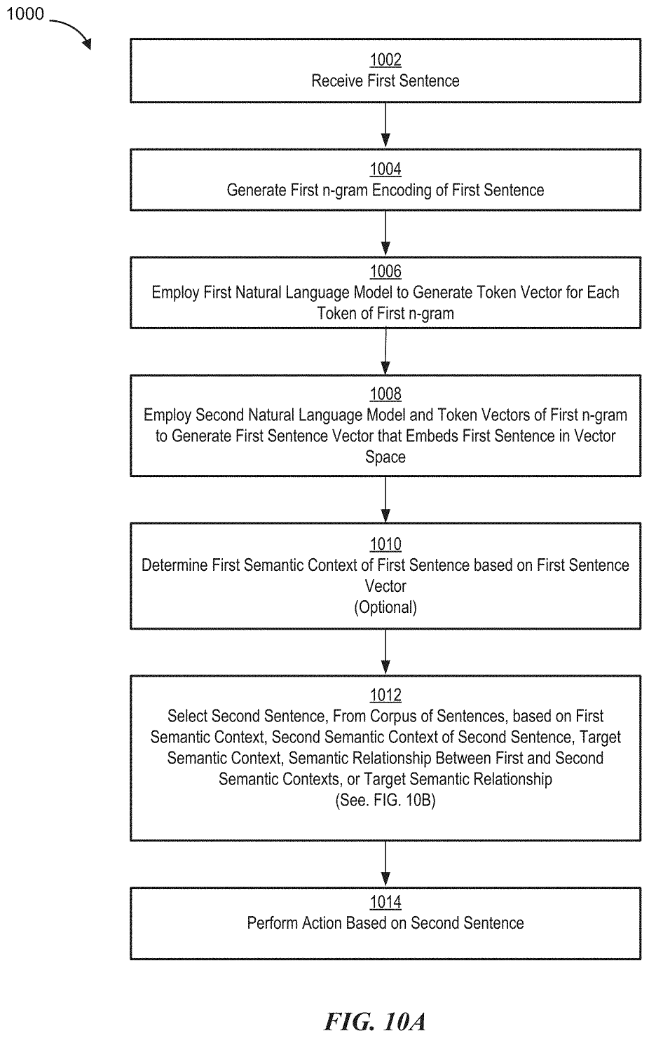

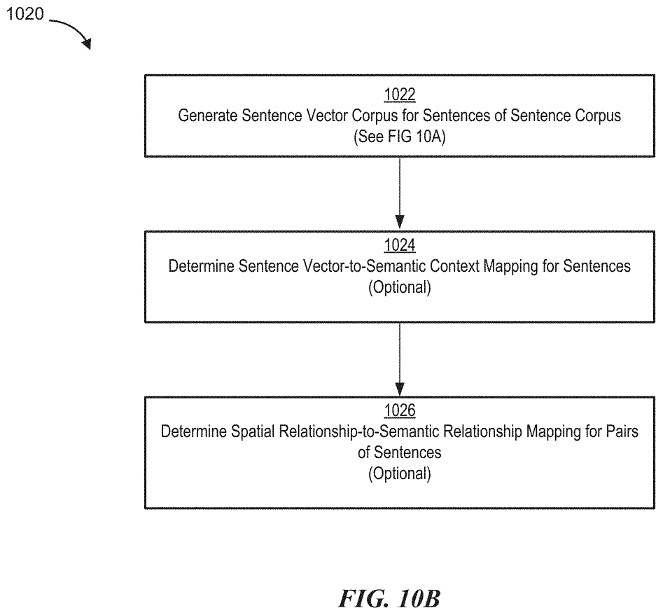

FIGS. 10A-10B illustrate processes 1000 and 1040 for generating sentence embeddings, according to various examples. Processes 1000 and/or 1020 may be performed, for example, using one or more electronic devices implementing a digital assistant. In some examples, processes 1000 and 1020 may be performed using a client-server system (e.g., system 100), and the blocks of processes 1000 and 1020 are divided up in any manner between the server (e.g., DA server 106, 8201) and one or more client device (e.g., any of devices 802-808). In other examples, the blocks of processes 1000 and 1020 are divided up between the server and multiple client devices (e.g., a mobile phone and a smart watch). Thus, while portions of processes 1000 and 1020 are described herein as being performed by particular devices of a client-server system, it will be appreciated that processes 1000 and 1020 are not so limited. In other examples, processes 1000 and 1020 are performed using only a client device (e.g., user device 104, 810A-810H) or only multiple client devices. In processes 1000 and 1020, some blocks are, optionally, combined, the order of some blocks is, optionally, changed, and some blocks are, optionally, omitted. In some examples, additional steps may be performed in combination with the processes 1000 and 1020.

FIG. 10A illustrates a process 1000 for generating and employing a semantic sentence embedding, according to various embodiments. Process 1000 begins at block 1002, where a first sentence (e.g., sentence 856 of FIG. 8) is received at an electronic device (e.g., any of devices 802-808 of FIG. 8). The first sentence may be in a first natural language and represents and/or includes a first semantic context in the first natural language. At block 1004, a first n-gram is generated encoding the first sentence (e.g., a first phrase of the first natural language). The first n-gram includes a first set of tokens that is an ordered set of tokens. The tokens of the first set of tokens may be tokens associated with the first language. Thus, the generated first n-gram may represent the first semantic context of the first sentence in the first natural language.

At block 1006, a first natural language model may be employed to generate a token vector for each token of the first n-gram. The first natural language model may be a word (or vector) embedding model. For example, a word contextualizer (e.g., word contextualizer 800 of FIG. 8) may be employed to generate the token embeddings. The word embedding model may be a contextual word embedding model, and the token vector of each token nay be based on the other tokens in the first set of tokens and/or the order of the first set of tokens. As discussed in conjunction with at least FIG. 8, the first language model may be a pre-trained Embeddings from Language Models (ELMo). The first language model may be installed on the electronic device.

At block 1008, a second language model and the token vectors of the first n-gram (generated at block 1006) may be employed to generate first sentence vector (e.g., sentence vector 852 of FIG. 8) that embeds the first sentence in a vector space of the second language model. That is, the first sentence vector may be a vector embedding of the first sentence in the vector space of the second language mode. Thus, the second language model may be a sentence embedding model. For example, a sentence embedder (e.g., sentence embedder 840 of FIG. 8) may be employed to generate the first sentence vector. As discussed in conjunction with at least FIG. 8, the second language may include at least a Bi-directional long short term memory (Bi-LSTM) neural network. In some embodiments, the second language model may include a fully connected (FC) neural network. The second language model may be installed on the electronic device. As such, first sentence vector for the first n-gram embeds the first semantic context within the vector space of the second language model.

As discussed in conjunction with at least FIG. 9, the second language model (e.g., the sentence embedding model) may be trained by employing the first language model (e.g., the word embedding model), a plurality of semantic tasks (e.g., multitask supervised training), and a loss function. The loss function may be a combination of one or more metrics associated with each of the plurality of tasks. The plurality of semantic tasks may include a natural language inference task. The natural language inference task may classify a semantic relationship between an ordered pair of natural language phrases. Training data for training the natural language inference task may include a plurality of ordered pairs of phrases. Each ordered pair of phrases of the plurality of ordered phrases may include a first phrase and a second phrase. The training data may be labeled with a ground truth relationship between the ordered pairs of phrases. The classification of the relationship between the ordered pair of phrases may include one of entailment, contradiction, or neutrality.

In some embodiments, the plurality of semantic tasks may include a semantic similarity inference task. A semantic similarity task may classify a similarity for a pair of sentences. Training data for the semantic text similarity task may include a plurality of pairs of phrases. Each pair of phrases of the plurality of phrases may include a first phrase and a second phrase. The training data may be labeled with a ground truth relationship between the ordered pairs of phrases. The classification of the similarity between the pair of phrases may include one of similar and not similar.

The plurality of semantic tasks may additionally and/or alternatively include a next phrase inference task. A next phrase inference task may classify a relationship between an ordered pair of natural language phrases. Training data for the natural language inference task may include a plurality of ordered pairs of phrases. Each ordered pair of phrases of the plurality of ordered phrases may include a first phrase and a second phrase. The training data may be labeled with a ground truth relationship between ordered pair of phrases. The classification of the relationship between the ordered pair of phrases may include one of logically deductive or not logically deductive.

At optional block 1010, the first semantic context of the first sentence may be determined and/or identified based on the first sentence vector. Various embodiments are discussed throughout for determining and/or identifying a semantic context of a sentence based on its vector embedding. In at least some embodiments, a sentence vector-to semantic mapping may be generated. The first semantic mapping may be determined by mapping the first sentence vector to a semantic context via such a sentence vector-to-semantic context mapping.

At block 1012, a second sentence is selected and/or identified from a corpus of sentences (e.g., a plurality of other sentences). Because sentences may be encoded in an n-gram data structure, selecting a second sentence may include selecting a second n-gram from a corpus of n-grams (e.g., a plurality of other n-grams). The second n-gram may include a second ordered set of tokens. Thus, the second n-gram may encode the second sentence (e.g., a second phrase of the second natural language). The second sentence, the second n-gram and/or the second set of tokens may represent a second semantic context. The second sentence, the second n-gram, and/or the second set of tokens may be associated with a second natural language. In some embodiments, the first and second natural languages are the same natural language. However, in other embodiments (e.g., those directed towards language translation between different languages), the first and second natural language may be separate and/or different natural languages (e.g., English and Spanish).

Selecting the second sentence may be based on at least one of the first semantic context of the first sentence, a second semantic context of the second sentence, and/or a semantic relationship between the first and second semantic contexts. In some embodiments, the selection of the second sentence (or second n-gram) may be based on a target semantic context and/or a target semantic relationship. Note that the target semantic context and/or target semantic relationship may be based at least on the first semantic context. Thus, the first semantic context may be determined in optional block 1010. As noted throughout, because a semantic context may be mapped to regions within the vector space of the second language model, the selection of the second sentence may be based on the first sentence vector and/or a second sentence vector that corresponds to the second sentence (e.g., a sentence embedding of the second sentence). As also noted throughout, because semantic relationships between the semantic contexts of pairs of sentences may be mapped to spatial relationships between their associated vector embeddings (e.g., a spatial relationship between the first and second sentence vectors), the selection of the second relationship may be based on a spatial relationship between the first and second sentence vectors. As discussed throughout, various embodiment may generate and employ a spatial relationship-to-semantic relationship. When selecting the second sentence, such a spatial relationship-to-semantic relationship may be employed to identify the semantic relationship the first sentence has to each other sentence in the corpus of sentences. The semantic relationship between the first and second semantic contexts may be such that the first semantic context is a paraphrasing of the second semantic context.

Various embodiments for employing the corpus of sentences (or corpus of n-grams), from which the second sentence is selected from are discussed in conjunction with at least FIG. 10B. However, briefly here, the second sentence may be, but need not be, included in the corpus of sentences. The corpus of sentences may serve as a database of reference sentences for which to match the first sentence vector to a second sentence vector that is a vector embedding of the second sentence. In various embodiments, a second sentence vector may be generated by employing the second n-gram as an input to each of the first and second language models. The second sentence vector may embed the second semantic context of the second sentence in the vector space of the second language model. A phrase-to-vector mapping or correspondence may be generated and stored (as structured data). The phrase-to-vector mapping may include a (one-to-one mapping) between the second sentence and/or its n-gram encoding and the corresponding second sentence vector. In such embodiments, the second sentence may be included in the corpus of sentences (e.g., a plurality of other sentences) and/or the second n-gram may be included in the corpus of n-grams (e.g., a plurality of other n-grams). The second sentence vector may be included in a corpus of sentence vectors (e.g., a plurality of other sentence vectors). Each sentence vector in the plurality of other sentence vectors may correspond to a sentence in the plurality of other sentences.

In at least one embodiment, the second sentence vector may be selected in response to receiving the first sentence. Once the second sentence vector is selected, its corresponding sentence (or second n-gram) may be determined. For example, the second sentence vector may be selected from the plurality of other sentence vectors (of the corpus of vectors) based on one or more distance criteria (e.g., one or more distance thresholds) and a distance between the first and second sentence vectors in the vector space. The distance may be determined based on a distance metric defined for the vector space. The selection of the second sentence vector may be based on the distance between the first sentence vector and each of the other sentence vectors in the plurality of sentence vectors. For example, the first and second sentence vectors may be “nearest neighbors” in the vector space, when considering all the sentence vectors in the plurality of other sentence vectors. The stored phrase-to-vector correspondence may be employed to identify and/or determined the second sentence and/or the second n-gram.

At block 1014, one or more actions may be performed based on the second sentence. The actions may vary and/or be based on one or more uses cases. Various uses cases, and corresponding actions are discussed below. However, briefly here, such actions may include, but are not otherwise limited to performing a search, executing a command, suggesting content (e.g., a poem), generating multimedia (e.g., parings of music and images), sorting content (e.g., electronic messages, files, internet bookmarks, event reminders for tasks, questions and the like) into content collections (e.g., folders, lists, FAQ data structures, and the like.

In at least some embodiments, the first sentence (or the first n-gram) may encode a first natural language phrase in the first natural language. The first sentence may be received via a spoken utterance of the user, or may be text-based (e.g., the user may type the first sentence into a command prompt line or machine language interpreter). The first semantic context of the first phrase may represent a user intent (e.g., an execution of one or more commands that are recognizable and/or executable by the electronic device and/or a digital assistance implemented by the electronic device). However, the first phrase may be a paraphrasing of the command that the user wishes to execute, but the first phrase is non-executable by the electronic device. For instance, the first phrase may be a spoken utterance of a paraphrasing of a command that is non-recognizable by a digital assistant implemented by the electronic device (e.g., “Hey Siri, what can I expect for the high temperature this afternoon and is it going to rain?”). The embodiments may select the second phrase (or a second n-gram), such that the second n-gram encodes (or at least includes an identifier for) the command that the user wishes to execute. That is, similar to the first semantic context of the first phrase encoding the user intent, a second semantic context of the second n-gram may also represent the user intent. Furthermore, the second n-gram be, or at least identify, a command that is executable by the electronic device. When the command is executed, the electronic device performs actions causing the accomplishment of the user's intent (e.g., receiving a weather report). For example, the second n-gram may encode a second phrase (or at least identify a command) that is recognizable by the digital assistant (e.g., “Hey Siri, what is the weather?”).

In some embodiments the first and second natural languages of the first and second n-grams may be a same natural language. Thus, each of the first and second n-grams include a first and a second ordered set of natural language tokens in the same language. Some non-limiting examples of natural languages include English, Spanish, French, German, Italian, Portuguese, Chinese, Japanese, Korean, Arabic, and the like. In other embodiments, the first and second languages may be different or separate natural language. Language translation services may be provided by the embodiments. For example, the user may want a translation of a first sentence in English (e.g., “I like my cat”) to Spanish. In such embodiments the target semantic relationship English to Spanish translation may be employed to return the second sentence “Me gusta mi gato.”

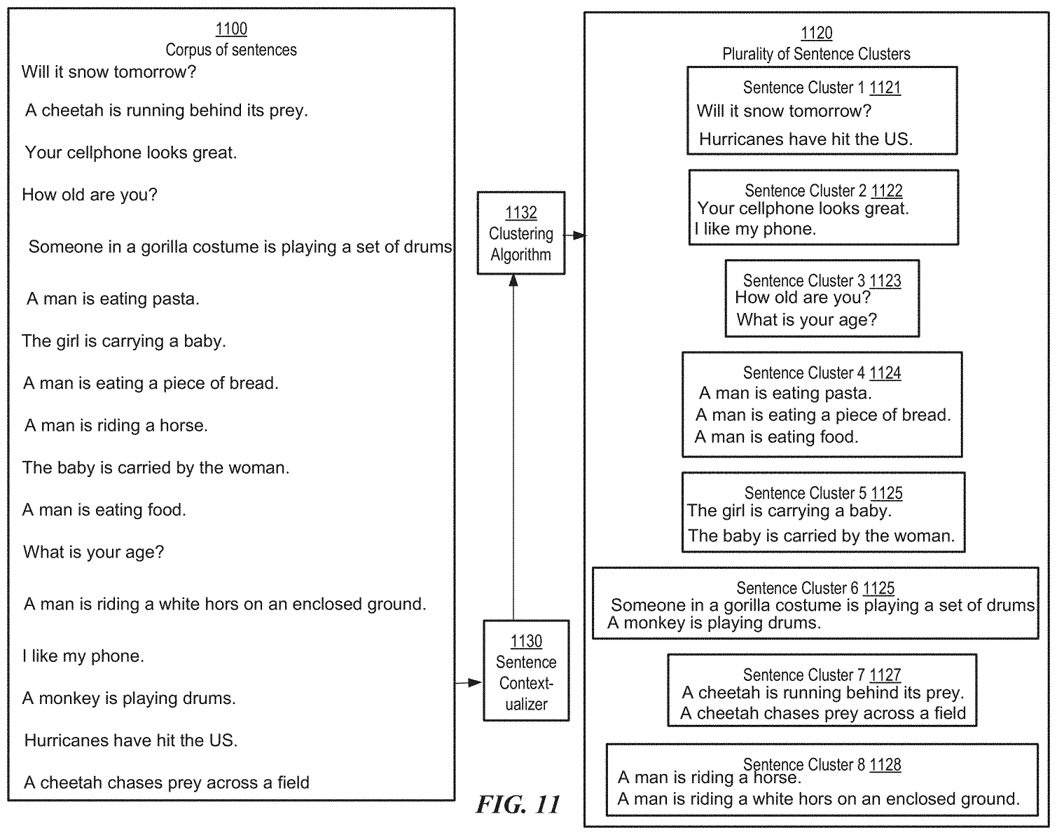

As discussed at least in conjunction with FIG. 11, some embodiments may be sentence cluster embodiments. In such embodiments, the plurality of other sentence vectors may form sentence clusters within the vector space of the second language model. Each sentence cluster may include one or more sentence vectors of the plurality of clusters. Because each sentence vector is a sentence embedding of a sentence in the plurality of other sentences, each sentence cluster may be associated with one or more sentences of the plurality of sentences. The clustering of sentences in the vector space may enable a determination of the sentence vector-to-sentence context mapping and/or the spatial relationship-to-semantic relationship mapping. Thus, the clustering of the sentences may be employed to select the second sentence (or second n-gram).

The sentence embeddings may be used in any application where associations between two (or more) sentences, based on a semantic relationship, are useful. In at least one embodiment, a user may be recommended one or more frequently asked questions (FAQs). Many applications, websites, and other information systems include FAQ content. In such systems, a user may manually search for a frequently asked question, and find a corresponding answer. In the embodiments, a user may be enabled to provide their, via spoken or text-based mechanisms. Their question may be a paraphrasing of a question in the FAQ content. Traditional search engines may not match the user's paraphrasing of the included questions. However, via sentence embeddings, the user's question may be automatically matched to a semantically similar, and thus relevant, question included in the content. Thus, the user may be automatically provided the corresponding answer to their paraphrased question.

In still other scenarios, the embodiments may be employed to pair content (e.g., electronic messages, files, internet bookmarks, reminders for tasks and/or events, and the like) with content collections (e.g., folders and/or lists that that organize the content). For example, if new content is received (e.g., a new email message) is received, the vector embeddings of sentences included in the new message may be compared to the vector embeddings of sentences in the messages already sorted by and/or stored in the available message folders. One or more folders that store semantically similar messages may be recommended to the user for storing their newly received message. Such embodiments may be used to recommend folders for files (e.g., in a file system), folders to store internet bookmarks (e.g., in a web browser), lists to include a reminder for a task and/or event (e.g., in a reminders or to-do list application), and the like.

In such embodiments, the first n-gram may encode a first phrase of the first natural language. The phrase may be provided by a user. The second n-gram may encode an identifier for a first content collection included in a plurality of content collections. Each of the plurality of other n-grams may encode natural language content that is included in one or more of a plurality of content collections. A plurality of other sentence vectors may have been previously generated by embedding each of the plurality of other n-grams in the vector space. The first content collection may be provided and/or recommended to the user.

Some embodiments may pair particular content with a received first sentence. For instance, a user may provide a sentence, e.g., “You're beautiful.” A content database may be searched to return content that includes a semantic context that is similar to the input sentence, via sentence embeddings of the inputted sentence and sentences associated with the content. Such content may include poetry, works of literature, music lyrics, captions (or other descriptive text) for images, and the like. Such similar content may be returned to the user based on matches between the sentence embeddings. One or more images, poems, novels, songs, movies, television shows, or the like may be returned based on matching the sentence embeddings. In the above example, where the user input the sentence “You're beautiful,” Sonnet 18 by William Shakespeare (e.g., a poem), an image of the user's spouse, or a love song may be returned to the user.

For such embodiments, the natural language content encoded in each content collection of the plurality of content collections may include at least a portion of a poem of a plurality of poems. First content (included in the first content collection) may be provided to a user. The first content may include at least a portion of a first poem of the plurality of poems. Each of the plurality of other n-grams includes at least a portion of one or more of the plurality of poems. The identifier for the first content collection may include at least one of a title of the first poem or an author of the first poem. The first natural language content includes at least a portion of the first poem.

Still other embodiments are directed towards frequently asked questions (FAQ) for information system. For instance, a user may provide a question that is a paraphrasing, similar question, and/or related to a question included in a FAQ data structure of the system. However, the user provided question may not exactly match a question already included in a FAQ data structure of the system. Traditional searches may not match the user provided question with a question already included in the system. Various sentence embedding embodiments may be employed to match the user provided question with questions and/or answers included in the system. The user provided question may be received as the first n-gram. The second n-gram may include an identifier for a FAQ data structure included in the system.

Other embodiments pair various types of content to generate multimedia presentations of the paired content. In one non-limiting embodiment, images and music may be paired based on sentence embeddings. The pairings of an image and a song may be presented such that the image is displayed on a device's display, while the device plays the song. For example, one or more sentences included in a caption (or other descriptive text) for one or more images may be embedded in the vector space. The descriptive text maybe manually generated and/or generated via automated means (e.g., text generated via trained image classifiers). Additionally, sentences included in the lyrics for one or more songs may be embedded in the vector space. Associations between the sentence embedding may be determined to pair images with songs with lyrics that are semantically similar to text describing the image (e.g., a caption for the image). In some embodiments, multimedia slide shows and/or slide decks may be automatically generated by the various embodiments.

In such embodiments, a first image and a corresponding first caption (or other descriptive text corresponding to the image) of the first image are received. The first n-gram may be selected from the first caption. The second n-gram may identify a first audible content collection (e.g., an audio file) within a plurality audible content collections (e.g., a library of audio files). Each audio file may encode a separate song. Thus, the first audible content collection may include a first song. The plurality of other sentences include lyrics from the songs, and the plurality of other sentence vectors include the vector embeddings of the lyrics. Thus, content visually depicted in the first image may have a semantic relationship to the lyrics of the first song. The first image may be displayed on a display device of the electronic device and the first song may be played through a speaker device of the electronic device. The display of the first image and the playing of the first song may happen simultaneously and/or

At least one embodiment may include using sentence embeddings to train a classifier model. Such embodiments may include accessing a set of classifier training data. The set of classifier training data may include a plurality of n-grams. Each of the plurality of n-grams may be labeled with a ground truth that classifies the corresponding n-gram as a classification of a plurality of classifications. The first and second language models may be employed to embed each of the plurality of n-grams in the vector space of the second language model. The sentence embeddings, the ground truth labels, and a supervised machine learning (ML) method may be employed to train a classifier model. In some embodiments, the trained classifier model classifies the semantic relationship between semantic contexts of two sentences. The classifier model may classify the semantic relationship based on the spatial relationship between the vector embeddings corresponding to the two sentences.

Another embodiment is directed toward image search engines. Vector embeddings for sentences included in textual descriptions for an image may be generated. A collection of images may be indexed via the sentence embeddings of the corresponding textual descriptions. Such an index may be employed by an image search engine. In at least one embodiment, the text may be a caption for an image. In some embodiments, the text may be generated automatically, via by one or more image classifier models. In some embodiments, an image model (e.g., an image scene model) may be trained to embed images in a vector space of the image scene model (e.g., a second vector space). For each image of a set of images, the image scene model may be employed to embed the image in the second vector space. Thus, a plurality of image embeddings may be generated via the image scene model. Also for each image in the set of images, sentences included in the textual description of the image may be embedded in the vector space of the second language model. The vector embeddings of the textual descriptions of the images may be included in the plurality of other sentence vectors (e.g., the corpus of sentence embeddings). In various embodiments, a mapping model may be trained to generate a mapping model between the first vector space of the second language model and the second vector space of the image scene model. More specifically, the mapping model generate a correspondence between one or more sentence vectors (in the vector space of the second language model) and one or more image vectors (on the second vector space of the image scene model).

A search engine may employ the image embeddings, the sentence embeddings, and the mapping model. For example, a textual search query may be received by an image search engine. The search query may be encoded as the first n-gram. The first sentence vector may be generated via the first and second language models. The first sentence vector may by mapped to the second vector space. Via the mapping model, the first sentence vector may be mapped to one or more images in the second vector space (e.g., a subset of the set of images). The image search engine may return or provide, to the user, an indication of images included in the subset of images.

Turning attention to FIG. 10B, FIG. 10B illustrates a process 1020 for generating a database of reference sentence embeddings, consistent with various embodiments. At block 1022, for each sentence in a corpus of sentences, generating a corresponding sentence vector. (See blocks 1002-1008 of FIG. 10A). The corpus of sentence may include any sentences found in any content collection or collection of content collections, e.g., messages and/or folders in a messing application, files and/or folders in a file system, the content (e.g., questions and answers) included in FAQs, image captions, song lyrics, websites, folders of website bookmarks, poems, literature, reminders for events or tasks, lists of tasks, list of commands recognized by a computing environment (e.g., a digital assistant) and the like. The corpus of sentences may be virtually any content that includes one or more sentences. In some embodiments a sentence-to-vector (or a phrase-to-vector) mapping and/or correspondence that includes a one-to-one mapping between sentences (or their n-gram encodings) to their corresponding sentence vector. This database of reference sentences and their mapping to their corresponding sentence vectors may be employed in the various embodiments.

At optional block 1024, a sentence vector-to-semantic context mapping may be generated for the corpus of sentences. In some embodiments, a sentence vector-to-semantic context mapping may map individual sentence vectors to one or more semantic contexts. In at least one embodiment, a sentence vector-to-semantic context mapping may map volumes (e.g., regions) of the second language model's vector space to one or more semantic contexts. As discussed throughout, the sentence vector-to-semantic context mapping may be generated by various methods, including but not limited to supervised machine learning (e.g., employing sentence embeddings to train a classifier model) and/or unsupervised machine learning (e.g., generating clusters of sentence vectors from the sentence embeddings of the corpus of sentences).

At optional block 1026, a spatial relationship-to-semantic relationship mapping may be generated for pairs of sentences in the corpus of sentences may be generated. In some embodiments, a spatial relationship-to-semantic mapping may map a spatial relationship between the vector embeddings of two sentences to a semantic relationship between the semantic contexts of the two sentences. Such a spatial relationship may include the absolute and/or relative positions of each of the sentence vectors in the vector space, as well one or more distance metrics defined over the vector space. Such distance metrics may include, but are not limited to, Euclidean distance, Manhattan distance, Minkowski distance, Chebyshev distance, cosine distance, or any other such distance metric. The spatial relationship between the two sentence vector may be based on various vector operations on the two vectors, such as but not limited to vector inner products, vector outer products, vector cross products, vector addition, vector subtraction, cosine similarity, and the like. As discussed throughout, the spatial relationship-to-semantic relationship mapping may be generated by various methods, including but not limited to supervised machine learning (e.g., employing sentence embeddings of pairs of sentences to train a classifier model) and/or unsupervised machine learning (e.g., generating clusters of sentence vectors from the sentence embeddings of the corpus of sentences).

Process 1020 may be employed to generate a plurality of other sentence vectors. The plurality of other sentence vectors may constitute a database of reference sentence vectors (e.g., a corpus of sentence vectors corresponding to the corpus of sentences). The plurality of other sentence vectors may be generated by employing each of the plurality of other n-grams (e.g., a corpus of n-grams encoding the corpus of sentences) as an input to the first and second language models (e.g., the word embedding language model and the sentence embedding language model). A sentence contextualizer, which implements the first and second language models, may be employed to generate the plurality of other sentence vectors. In some embodiments, the sentence embeddings may be employed to train a semantic context classifier model and/or a semantic relationship classifier model. Such classifiers may be trained to determine the sentence vector-to-semantic context mapping for sentence vectors and/or the spatial relationship-to-semantic relationship mapping for pairs of sentence vectors.

As noted above, other embodiments may be sentence clustering embodiments. FIG. 11 illustrates a non-limiting example of employing a clustering method to generate a plurality of sentence clusters from a corpus of sentences. Sentence embeddings for each sentence in a corpus of sentences 1100 are generated by inputting the sentences into a sentence contextualizer (e.g., sentence contextualizer 800 of FIG. 8). The sentence vectors are fed as input to a clustering algorithm 1132 to generate a plurality of sentence clusters 1120. The clustering algorithm 1132 may include one or more unsupervised cluster methods. Such clustering methods may include, but are not limited to, partitioning methods (e.g., k-means), hierarchical methods, fuzzy clustering methods, density-based clustering methods, model-based clustering methods, and the like. A centroid and/or at least an approximate boundary (within the vector space) may be determined to define each cluster. As shown in FIG. 11, the plurality of sentence clusters 1120 includes 8 sentence clusters: sentence cluster 1 1121, sentence cluster 2 1122, sentence cluster 3 1123, sentence cluster 4 1124, sentence cluster 5 1125, sentence cluster 6 1126, sentence cluster 7 1121, and sentence cluster 8 1128. Note that each of the plurality of sentence clusters 1120 includes sentences that are semantic related via a semantically similar semantic relationship between the semantic contexts of the sentences included in the sentence cluster.

More specifically, a cluster method (e.g., clustering algorithm 1132) may be employed to generate a set of sentence clusters within the vector space of the second model. Each sentence cluster may include one or more sentence vectors of the plurality of sentence vectors. For each sentence cluster, a centroid and/or at least an approximate boundary within the vector space may be determined. A particular centroid for a particular sentence cluster of the set of sentence clusters may be based on the distance metric defined for the vector space and one or more particular sentence vectors of the plurality of sentence vectors. The one or more particular sentence vectors may be included in the particular sentence cluster. The cluster of embedded sentences may be employed to determine the sentence vector-to-semantic context and/or the spatial relationship-to-semantic relationship mapping.

To select the second sentence, a first sentence cluster of the set of sentence clusters may be selected. Selecting the first sentence cluster may be based on the first sentence vector and the centroid for each sentence cluster in the set of sentence clusters. The second sentence vector may correspond to (or at least identify) the first sentence cluster and/or a first centroid of the first sentence cluster. Selecting the second sentence vector may further be based on the spatial relationship between the first and second sentence vectors (which indicates the semantic relationship between the first and second semantic contexts via the spatial relationship-to-semantic relationship mapping) and a target semantic relationship. The spatial relationship may be based on the distance metric. In some embodiments, the first centroid is a closest centroid of the set of sentence clusters to the first sentence vector. Selecting the second sentence (or second n-gram) may be based on an association of the second sentence with the first sentence cluster. For example, the second sentence may identify the first cluster, or be included in the first cluster.

The operations described above with reference to FIGS. 10A-11 are optionally implemented by components depicted in FIGS. 1-4, 6A-B, 7A-C, and 8-9. For example, the operations of processes 1000 and 1020 may be implemented by sentence contextualizer 800 discussed in conjunction with FIG. 8. It would be clear to a person having ordinary skill in the art how other processes are implemented based on the components depicted in FIGS. 1-4, 6A-B, 7A-C, and 8-9.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method for operating an electronic device, the method comprising:
in accordance with receiving a first n-gram at the electronic device, employing one or more processors and a memory of the electronic device to perform operations, wherein the first n-gram includes a first set tokens and represents a first semantic context within a first natural language associated with the first n-gram, the first set of tokens being an ordered set of tokens of the first natural language, and the operations comprising:
employing a first language model to generate a token vector for each token in the first set of tokens;
employing a second language model and the token vector of each token in the first set of tokens to generate a first sentence vector for the first n-gram that embeds the first semantic context within a vector space of the second language model; and
selecting, from a plurality of other n-grams, a second n-gram based on a semantic relationship between the first semantic context and a second semantic context represented by the second n-gram, wherein the semantic relationship is based on the first sentence vector, and the second n-gram is associated with a second natural language.

2. The method of claim 1, wherein the first n-gram encodes a first phrase in the first natural language that is non-executable by the electronic device, the first semantic context includes a user intent in accordance with the first phrase, and the second n-gram encodes an identifier for a command that is executable by the electronic device, such that executing command causes the electronic device to performs actions causing an accomplishment of at least a portion of the user intent.

3. The method of claim 1, wherein the first n-gram encodes a first phrase in the first natural language, the first phrase being non-recognizable by a digital assistant implemented by the electronic device, the first semantic context includes a user intent in accordance with the first phrase, the second n-gram encodes a second phrase in the second natural language, the second phrase being recognizable by the digital assistant, and the second semantic context includes the user intent, which is in accordance with the second phrase.

4. The method of claim 1, wherein the first n-gram is received through a spoken utterance of a user.

5. The method of claim 1, wherein the first and second natural languages are a same natural language, the second n-gram includes a second set of tokens and represents the second semantic context within the same natural language associated with the each of the first and second n-grams, the second set of tokens being an ordered set of tokens of the same natural language.

6. The method of claim 1, wherein the first n-gram encodes a first phrase that is a first natural language phrase, the second n-gram encodes a second phrase that is a second natural language phrase, and the method further comprises:
generating a second sentence vector by employing the second n-gram as an input to each of the first and second language models such that the second sentence vector embeds the second semantic context in the vector space;
storing a phrase-to-vector correspondence that includes a one-to-one mapping between the second n-gram and the second sentence vector;
including the second n-gram in the plurality of other n-grams, wherein each of the plurality of other n-grams encodes one of a plurality of phrases that are natural language phrases;
including the second sentence vector in a plurality of other sentence vectors, wherein each sentence vector in the plurality of other sentence vectors corresponds to a particular phrase in the plurality of other phrases;
in response to receiving the first n-gram, selecting, from the plurality of other sentence vectors, the second sentence vector based on one or more distance criteria and a distance between the first and second sentence vectors, as determined based on a distance metric defined for the vector space; and
employing the phrase-to-vector correspondence to identify the second n-gram from the plurality of other n-grams.

7. The method of claim 1, wherein the first and second natural languages are separate natural languages, the first n-gram is a first phrase in the first natural language, the second n-gram is a second phrase in the second natural language, and the semantic relationship between the first and second semantic contexts is a translation of the first phrase in the first natural language to the second phrase in the second natural language.

8. The method of claim 1, further comprising:
generating a plurality of other sentence vectors by employing each of the plurality of other n-grams as an input to the first and second language models;
employing a clustering algorithm to generate a set of sentence clusters within the vector space, wherein each sentence cluster of the set of sentence clusters includes one or more sentence vectors of the plurality the sentence vectors;
determining, for each sentence cluster in the set of sentence clusters, a centroid, wherein a particular centroid for a particular sentence cluster of the set of sentence clusters is based on a distance metric defined for the vector space and one or more particular sentence vectors, of the plurality of sentence vectors, that are included in the particular sentence cluster;
selecting a first sentence cluster of the set of sentence clusters based on the first sentence vector and the centroid for each sentence cluster in the set of sentence clusters, wherein a second sentence vector associated with the second n-gram corresponds to a first centroid of the first sentence cluster, and a spatial relationship between the first and second sentence vectors indicates, based on the distance metric, that the first centroid is a closest centroid of the set of sentence clusters to the first sentence vector; and
selecting the second n-gram based on an association of the second n-gram with the first sentence cluster.

9. The method of claim 8, further comprising:
receiving a first data structure that includes the first n-gram, wherein an application installed on the electronic device has access to a set of data structures that does not include the first data structure, each sentence cluster of the set of sentence clusters corresponds to a separate subset of the set of data structures, the second n-gram encodes an identifier for a particular subset of data structures, and the first cluster corresponds to the particular subset of data structures; and
generating an association between the first data structure and the identifier associated with the particular subset of data structures.

10. The method of claim 9, wherein generating the association between the first data structure and the identifier associated with the particular subset of data structures includes:
providing, to a user, the identifier for the particular subset of data structures; and
in response to receiving, from the user, a selection of the identifier for the particular subset of data structures, including the first data structure in the particular subset of data structures.

11. The method of claim 1, wherein the first n-gram is included in a received first electronic message, the second n-gram encodes an identifier for a first folder of a plurality of message folders for a messaging application installed on the electronic device, each of the plurality of other n-grams is included in one or more of a plurality of other electronic messages that does not include the first electronic message, a plurality of other sentence vectors were generated by embedding each of the plurality of other n-grams in the vector space, each of the plurality of other electronic messages are associated with one or more folders of the plurality of message folders, and the operations further comprise at least one of:
providing a notification that indicates a recommendation for associating the first electronic message with the first folder; or
associating the first electronic message with the first folder.

12. The method of claim 1, wherein the first n-gram is included in first website, the second n-gram encodes an identifier for a first folder of a plurality of bookmark folders for a web browsing application installed on the device, each of the plurality of other n-grams is included in one or more of a plurality of other websites that does not include the first website, a plurality of other sentence vectors were generated by embedding each of the plurality of other n-grams in the vector space, an address for each of the plurality of other websites is associated with one or more folders of the plurality of bookmark folders, and the operations further comprise at least one of:
providing a notification that indicates a recommendation for associating a first address for the first website in the first folder; or
associating the first address with the first folder.

13. The method of claim 1, wherein the first n-gram is included in a first event indicator, the second n-gram encodes an identifier for a first list of a plurality of lists for an event reminder application installed on the electronic device, each of the plurality of other n-grams is included in one or more of a plurality of other event indicators that does not include the first event indicator, a plurality of other sentence vectors were generated by embedding each of the plurality of other n-grams in the vector space, each of the plurality of other event indicators are associated with one or more lists of the plurality of lists, and the operations further comprise at least of:
providing a notification that indicates a recommendation for associating the first event indicator with the first list; or
associating the first with the first list.

14. The method of claim 1, wherein the first n-gram is included in a first data file, the second n-gram encodes an identifier for a first folder of a plurality of file folders for a file system of the electronic device, each of the plurality of other n-grams is included in one or more of a plurality of other data files that does not include the first data file, a plurality of other sentence vectors were generated by embedding each of the plurality of other n-grams in the vector space, each of the plurality of other data files are associated with one or more folders of the plurality of file folders, and the operations further comprise of at least one of:
providing a notification that indicates a recommendation for associating the first data file with the first folder; or
associating the first data file with the first folder.

15. The method of claim 1, wherein the first n-gram encodes a first phrase of the first natural language that is provided by a user, the second n-gram encodes an identifier for a first content collection included in a plurality of content collections, each of the plurality of other n-grams encodes natural language content that is included in one or more of a plurality of content collections that includes the first content collection, a plurality of other sentence vectors were generated by embedding each of the plurality of other n-grams in the vector space, and the operations further comprise:
providing, to a user, at least one of an identifier for the first content collection or a portion of first natural language content included in the first content collection to the user.

16. The method of claim 15, wherein the natural language content encoded in each content collection of the plurality of content collections includes at least a portion of a poem of a plurality of poems, the first content included in the first content collection includes at least a portion of a first poem of the plurality of poems, each of the plurality of other n-grams includes at least a portion of one or more of the plurality of poems, the identifier for the first content collection includes the at least one of a title of the first poem or an author of the first poem, and the first natural language content includes at least a portion of the first poem.

17. The method of claim 15, wherein each content collection of the plurality of content collections is includes one of a frequently asked question (FAQ) data structure that encodes at least a question and a corresponding answer, the first n-gram represents a second question not included the questions of a plurality of FAQ data structures, the first content collection is a first FAQ data structure of the plurality of FAQ data structures that encodes a first question and a first answer to the first question, the first question being related to the second question based on the relationship between the first and second semantic contexts, each of the plurality of other n-grams includes one or more natural language phrases included in one or more of the plurality of FAQ data structures, and the content provided to the user includes at least one of the first question or the first answer.

18. The method of claim 1, the method further comprises:
receiving a first image and a corresponding first caption of the first image that includes the first n-gram;
identifying a first audible content collection of a plurality audible content collections based on the second n-gram, wherein the first audible content collection includes first audible content, a plurality of other sentence vectors were generated from a plurality of other n-grams included in textual content associated with one or more of the plurality of audible content collections;
causing display of the first image on a display device of the electronic device; and
causing playing of at least a portion of the first audible content through a speaker device of the electronic device.

19. The method of claim 18, wherein each content collection of the plurality of content collections is an audio file of a plurality of audio files, content encoded in each audio file is a separate song of a plurality of songs, the first audible content collection is a first audio file of the plurality of audio files, the first audio file encodes a first song of the plurality of songs, the textual content associated with each of the plurality of audio files includes lyrics for the corresponding song, and the playing is the first song is concurrent with the display of the first image.

20. The method of claim 1, further comprising:
for each image of a set of images, employing an image scene model to embed the image in a second vector space, wherein each image of the set of images is associated with a natural language phrase;
for each image of the set of images, employing the first and second language models to embed the natural language phrase associated with the image in the vector space;
training a mapping model to generate a map between the vector space and the second vector space;
receiving an image search query that includes the n-gram;
employing the mapping model to generate at least one of a first correspondence between the first sentence vector and the second vector space or a second correspondence between a second sentence vector corresponding to the second n-gram and the second vector space;
employing the image embeddings, the natural language phrase embeddings, and at least one of the first correspondence and the second correspondence, to perform an image search based on the image search query, wherein the image search identifies a subset of the set of images; and
providing an indication of one or more images included in the subset of images to a user of the electronic device.

21. The method of claim 1, further comprising:
accessing a set of classifier training data that includes a plurality of n-grams, wherein each of the plurality of n-grams is labeled with a ground truth that classifies the corresponding n-gram as a classification of a plurality of classifications;
employing the first and second language models to embed each of the plurality of n-grams in the vector space; and
employing the embeddings, the ground truth labels, and a supervised machine learning (ML) method to train a classifier model.

22. The method of claim 21, wherein the trained classifier model classifies a semantic relationship between the first and second semantic contexts based on a spatial relationship between the first sentence vector and a second sentence vector corresponding to the second n-gram.

23. The method of claim 1, wherein the first language model is a pre-trained Embeddings from Language Models (ELMo) that is installed on the electronic device and the token vector for each token in the first set of tokens is based on each of the other tokens in the first set of tokens and the order of the first set of tokens.

24. The method of claim 1, wherein the second language includes a Bi-directional long short term memory (Bi-LSTM) neural network and a fully connected (FC) neural network, and the second language model is installed on the electronic device.

25. The method of claim 1, wherein the second language model was trained by employing a plurality of semantic tasks that includes a natural language inference task that classifies a relationship between an ordered pair of natural language phrases, wherein training data for the natural language inference task includes a plurality of ordered pairs of phrases, each ordered pair of phrases of the plurality of ordered phrases includes a first phrase and a second phrase and is labeled with a ground truth relationship between ordered pair of phrases, wherein the classification of the relationship between the ordered pair of phrases includes one of entailment, contradiction, or neutrality.

26. The method of claim 1, wherein the second language model was trained by employing a plurality of semantic tasks that includes a semantic similarity inference task that classifies a similarity for a pair of sentences, wherein training data for the semantic text similarity task includes a plurality of pairs of phrases, each pair of phrases of the plurality of phrases includes a first phrase and a second phrase and is labeled with a ground truth relationship between pair of phrases, wherein the classification of the similarity between the pair of phrases includes one of similar and not similar.

27. The method of claim 1, wherein the second language model was trained by employing a the plurality of semantic tasks includes that a next phrase inference task that classifies a relationship between an ordered pair of natural language phrases, wherein training data for the natural language inference task includes a plurality of ordered pairs of phrases, each ordered pair of phrases of the plurality of ordered phrases includes a first phrase and a second phrase and is labeled with a ground truth relationship between ordered pair of phrases, wherein the classification of the relationship between the ordered pair of phrases includes one of logically deductive or not logically deductive.

28. The method of claim 1, wherein the semantic relationship between the first and second semantic contexts is such that the first semantic context is a paraphrasing of the second semantic context.

29. The method of claim 1, wherein the second n-gram is selected further based on a spatial relationship between the first sentence vector and a second sentence vector corresponding to the second n-gram and the spatial relationship is employed to determine the semantic relationship between the first and second semantic contexts.

30. The method of claim 1, wherein the second language model was trained by employing the first language model, a plurality of semantic tasks, and a loss function that includes a combination of one or more metric associated with each of the plurality of semantic tasks.

31. An electronic device, comprising:
one or more processors;
a memory; and
one or more programs, wherein the one or more programs are stored in the memory and configured to be executed by the one or more processors, the one or more programs including instructions for operating the electronic device, and the instructions include operations comprising:
receiving a first n-gram at the electronic device, wherein the first n-gram includes a first set tokens and represents a first semantic context within a first natural language associated with the first n-gram, the first set of tokens being an ordered set of tokens of the first natural language
employing a first language model to generate a token vector for each token in the first set of tokens;
employing a second language model and the token vector of each token in the first set of tokens to generate a first sentence vector for the first n-gram that embeds the first semantic context within a vector space of the second language model; and
selecting, from a plurality of other n-grams, a second n-gram based on a semantic relationship between the first semantic context and a second semantic context represented by the second n-gram, wherein the semantic relationship is based on the first sentence vector, and the second n-gram is associated with a second natural language.

32. A non-transitory computer-readable storage medium storing one or more programs, the one or more programs comprising instructions for operating an electronic device, when the instructions are executed by one or more processors of the electronic device, cause the electronic device performs operations comprising:
receiving a first n-gram at the electronic device, wherein the first n-gram includes a first set tokens and represents a first semantic context within a first natural language associated with the first n-gram, the first set of tokens being an ordered set of tokens of the first natural language
employing a first language model to generate a token vector for each token in the first set of tokens;
employing a second language model and the token vector of each token in the first set of tokens to generate a first sentence vector for the first n-gram that embeds the first semantic context within a vector space of the second language model; and
selecting, from a plurality of other n-grams, a second n-gram based on a semantic relationship between the first semantic context and a second semantic context represented by the second n-gram, wherein the semantic relationship is based on the first sentence vector and the second n-gram corresponds to a second natural language.
